(19) United States
(12) Patent Application Publication
(10) Pub. No.: US 2024/0396060 A1
(43) Pub. Date: Nov. 28, 2024

(54) A FUEL CELL

(71) Applicant: BRAMBLE ENERGY LIMITED, Crawley (GB)

(72) Inventors: Thomas James MASON, Crowborough (GB); Erik Charles ENGEBRETSEN, London (GB)

(21) Appl. No.: 18/696,699

(22) PCT Filed: Sep. 30, 2022
(86) PCT No.: PCT/GB2022/052489

§ 371 Date: Mar. 28, 2024

(30) Foreign Application Priority Data
Sep. 30, 2021 (GB) 2114028.0

(51) Int. Cl. H01M 8/0202; H01M 8/0247; H01M 8/0263; H01M 8/0276; H01M 8/04029; H01M 8/10; H01M 8/1004

(52) U.S. Cl. CPC H01M 8/0269; H01M 8/0247; H01M 8/0263; H01M 8/0276; H01M 8/04029; H01M 8/1004; H01M 2008/1095

(57) ABSTRACT

The present disclosure provides a fuel cell comprising at least one fuel cell board (200), (400). Each fuel cell board (200), (400) comprises a Membrane Electrode Assembly (MEA) (113) comprising at least one ion permeable membrane, at least one anode, and at least one cathode, wherein each or all anodes are arranged on a first surface of the ion permeable membrane and each or all cathodes are arranged on a second surface of the ion permeable membrane. Each fuel cell board (200), (400) also comprises a first printed circuit board (PCB) layer (101), (401) comprising at least one first fluid path. Each fuel cell board also comprises a second PCB layer comprising (102), (402) at least one second fluid path. The MEA (113) is located between the first PCB layer (101), (401) and the second PCB layer (102), (402) so that the at least one first fluid path is arranged adjacent to each or all of the cathodes such that an oxidisable fluid flows to each or all of the cathodes of the at least one fuel cell board (200), (400) and so that the at least one second fluid path is arranged adjacent to each or all of the anodes such that a reducible fluid flows to the each or all of the anodes of the at least one fuel cell board (200), (400). The MEA (113), the first PCB layer (101). (401) and the second PCB layer (102), (402) are laminated together to form the fuel cell board (200), (400).

The present disclosure relates to fuel cells, uses of fuel cells, methods of using fuel cells and methods of decoupling coolant fluid flow in a fuel cell.

### BACKGROUND

A fuel cell (e.g. a solid-polymer-electrolyte fuel cell) is an electrochemical device which generates electrical energy and heat from a reactant or oxidant (e.g. pure oxygen or air) and a fuel (e.g. hydrogen or a hydrogen-containing mixture, or a hydrocarbon or hydrocarbon derivative). Fuel cell technology finds application in stationary and mobile applications, such as power stations, vehicles and laptop computers.

Typically, a fuel cell comprises two electrodes, an anode and a cathode, separated by an electrolyte membrane that allows ions (e.g. hydrogen ions), but not free electrons, to pass through from one electrode to the other. A catalyst on the electrodes accelerates a reaction with the fuel on the anode to separate electrons and protons/cations, and oxidant on the cathode to undergo a reduction reaction to water. A circuit can then be formed between the anode and the cathode generate a current to power e.g. an electrical device. A reactant fluid, e.g. oxygen or reactant air, is supplied to the cathode and a fuel, e.g. hydrogen, is supplied to the anodes.

A single pair of electrodes separated by an electrolyte membrane is called a membrane electrode assembly (MEA). A fuel cell MEA operating under a moderate load produces an output voltage of about 0.7V, which is often too low for many practical considerations. In order to increase this voltage, MEAs are typically assembled into a stack as shown in FIG. 1. Each MEA 1 has a layer of electrolyte membrane 1a (such as a Nafion™ membrane), which comprises an ion-permeable membrane sandwiched between two electrode layers, and an anode 2 and a cathode 3 on either side of the electrolyte membrane. Adjacent MEAs can be separated by an electrically conducting bipolar separator plate 4, and a fuel (e.g. hydrogen) 5 and an oxidant 6 (e.g. oxygen gas or ‘reactant air’) flow through the channels provided on opposing sides of the bipolar plate. End plates 9 are connected to an external circuit via an electrical connector 7, 8. The number of these MEAs in a stack in a fuel cell determines the total voltage, and the surface area of each membrane electrode determines the total current. Catalyst layers adjacent to the electrodes increase the rate of and efficiency of the reactions at the electrodes

FIG. 2 shows an exemplary fuel cell of the prior art (see e.g. WO 2012/117035) in which a plurality of fuel cell boards 22 are stacked between two endplates 21 in order to provide increased voltage and power. Electrode pairs are arranged in a series along either side of a single layer of polymer electrolyte 10, such as a Nafion™ membrane. Anodes 11 are disposed on one surface of these membranes and cathodes 12, separated by gaps are disposed on the other, opposite, surface of these membranes. The anode and cathode respectively of two adjacent electrode pairs may partially overlap. Through-membrane electrical connectors 13 connect the electrodes across the membrane in the overlapping region, and may be produced by a homogeneous chemical deposition process. A catalyst layer adjacent to the electrodes encourages the reactions at the electrodes. A fuel 17, such as hydrogen gas, flows along the face of the fuel cell board 22 supplying the anodes 11 and a reactant or oxidant 16, such as oxygen gas or air, flows along the surface of the fuel cell board 22 supplying the cathodes 12. One electrode at the edge of the upper surface and one electrode at another edge of the lower surface of the fuel cell board are connected to an external circuit via an electrical connection 18, 19. In this series arrangement, the surface area of an electrode pair determines the size of the current for a fuel cell board 22, but the voltage accumulates in proportion to the number of electrode pairs on that fuel cell board 22.

Electrically insulating spacers 20 can be integrated into the stack between each of the fuel cell boards each comprising a spacer composed of electrically insulating material (such as plastic).

The size of an individual cell (the surface area of a pair of electrodes) determines the size of the current for a fuel cell board. The total number of individual cells on a fuel cell board determines the voltage produced. The number of fuel cell boards in a stack determines the size of the total current of the fuel cell stack.

The end cathodes and anodes 11 on each fuel cell board are connected to respective first and second output lines via electrical connections 18, 19. The connection between each fuel cell board in the stack and the second output line can be controlled by a switch mechanism such as a field-effect transistor (FET) switch providing power handling and control directly at the cell. Each of these switches can be controlled by individual control lines.

There are a number of factors that determine the performance of a fuel cell. Maintaining the correct water content in the electrolyte membrane is essential to optimising a fuel cell's performance. The membrane requires a certain level of moisture to operate and conduct the ionic current efficiently so that the fuel cell current does not drop. Water produced by the cell is removed by the flow of fluid along the cathode or wicked away.

Overheating of the fuel cell stack can also cause problems and cooling is often required. This is generally achieved by supplying a coolant fluid (e.g. air or water) that circulates within the stack. In addition, a reactant fluid (e.g. oxygen or reactant air) is required by the cathodes to maintain a reaction. In the prior art set ups (see e.g. WO 2012/117035), the coolant and reactant fluids are supplied to the cathode in the same channel or flow.

Typically, a fuel cell is stacked in a bipolar configuration wherein the anode of one MEA opposes or faces the cathode of an adjacent MEA, and a bipolar separator plate is provided between the two MEAs to conduct the current from the anode of one MEA to the cathode of the adjacent MEA, such that the electrical current flows perpendicular to the plane of the MEAs. In such a bipolar configuration, since the anode of an MEA faces the cathode of an adjacent MEA, the coolant fluid is typically circulated within the fuel cell in combination with the reactant fluid in order to supply reactant to the cathodes and remove excess heat from within the fuel cell.

However, a coolant flow generally needs a higher flow rate in comparison to a reactant flow, and a combined flow removes required moisture from the cathodes, causing a reduction in the conductivity of ionic pathways and reducing fuel cell efficiency.

In view of the foregoing, it is desirable to provide improved fuel cells, fuel cell stacks, fuel cell designs and uses of these fuel cells.

### SUMMARY

An aspect of preferred embodiments provides a fuel cell comprising at least one fuel cell board. Each fuel cell board comprises a Membrane Electrode Assembly (MEA) comprising at least one ion permeable membrane, at least one anode, and at least one cathode, wherein each or all anodes are arranged on a first surface of the ion permeable membrane and each or all cathodes are arranged on a second surface of the ion permeable membrane. Each fuel cell board also comprises a first printed circuit board (PCB) layer comprising at least one first fluid path. Each fuel cell board also comprises a second PCB layer comprising at least one second fluid path. The MEA is located between the first PCB layer and the second PCB layer so that the at least one first fluid path is arranged adjacent to each or all of the cathodes such that an oxidisable fluid flows to each or all of the cathodes of the at least one fuel cell board and so that the at least one second fluid path is arranged adjacent to each or all of the anodes such that a reducible fluid can be flows to the each or all of the anodes of the at least one fuel cell board. The MEA, the first PCB layer and the second PCB layer are laminated together to form the fuel cell board.

Preferably, each or every fuel cell board of the fuel cell may comprise an MEA comprising at least one ion permeable membrane, at least one anode, and at least one cathode, a first printed circuit board (PCB) layer comprising at least one first fluid path and a second PCB layer comprising at least one second fluid path.

Preferably, in a single fuel cell board all of the anodes are on the same side of the ion permeable membrane and all cathodes are on the other side of the same ion permeable membrane

Traditional bipolar plates used in current fuel cell designs can be replaced by spacers or coolant plates. These too can comprise at least one PCB, and thus have all the advantages of PCB technology, and advantages of all of the plate components in a stack being manufactured from PCBs.

The presently described inventions are of a modular nature, where fuel cell boards can be stacked with means to cool the boards and/or means to provide the reactants to the fuel cell boards. The modular nature allows an increased control over the design of the fuel cell stacks, allowing for easy customisation in size, shape, power and voltage-current characteristics of the fuel cells. Individual boards can be individually switchable or removable, causing a change in capacity. Fuel cells of varying design can easily be manufactured from the same components.

PCB technology has the advantage of enabling the elements to be manufactured in large quantities and at low cost. For example, multiple flow field boards can be manufactured at the same time, by using thin laminate boards which are stacked and then simultaneously routed or drilled. Individually routed boards are then stacked and laminated together. PCBs have a high mechanical strength, whilst being light, and when laminated together provide a solid structure, with good contact between the individual layers. Accordingly, a monolithic, light, and completely sealed structure is produced. Use of PCBs also enables the present fuel cells, fuel cell boards and components to be constructed without a mass or size penalty which may be present using other materials such as metal. These can be easily plated with copper and/or have plated through holes or other means to conduct electrical current through the plates. This allows improved control of current through stacks, as not all of the plates, spacers etc need be conductive, like when prior art bipolar plates or conductive metal components are utilised in prior art stacks.

The present fuel cells also allow increased packing density of fuel cell boards, due to the nature of the presently described fuel cell boards. Compressed and laminated fuel cell boards as described herein have an inherent seal created, removing the need for gaskets between different fuel cell boards to seal boards together, as are found in traditional fuel cell stacks (which do not comprise laminated PCB fuel cell boards). The seal is formed because coolant plates or spacers are used between boards, sealing possible gaps between fuel cell boards that would otherwise inherently exist. Spacers and the herein described coolant plates, as well as having possible fluid paths for coolant and reactant when the fuel cell boards are stacked, have the functionality of providing a means to seal possible gaps between multiple fuel cell boards. This also results in electrical insulation of the boards in appropriate places.

These constructions also decrease costs of fuel cell manufacture due to less components being required (i.e. no separate gasket components to specifically seal between fuel cell boards are required), it also simplifies construction decreasing time of manufacture and cost of manufacture. Not requiring these gaskets means that stacking and manufacture of the fuel cell is quick and simple—fuel cell boards just need to be orientated so that the manifolds for the various reagents which need to be supplied to the fuel cell boards (e.g. reducible fluid, oxidisable fluid, coolant) line up, and then as many as needed can be stacked between two end plates and compressed to form a stack. Because the individual fuel cell boards are sealed, no gaskets are needed to seal the junctions between boards. The lack of need for gaskets and the fact boards line up with one another in stacks also allows manifold holes to be drilled in the same places on multiple plates, as manifold holes line up on adjacent plates.

Sealing and compression also improve overall efficiency of the fuel cell stacks. There is a reduction of ohmic loss when compared to prior art fuel cell stacks, where the MEA is not prepreg bonded and therefore not compressed to a specific value to avoid the ohmic losses.

Preferably, the spacers have a means to conduct electrical current from one face of the spacer to the other face. Preferably, the means to conduct electrical current can be substantially at only one end of the spacer. This allows the design and creation of conductive paths up/down a fuel cell stack. Fuel cell boards in a stack can be put in series or parallel depending on how these are configured.

The size of an individual cell (the surface area of a pair of electrodes) determines the size of the current for a fuel cell board. The total number of individual cells on a fuel cell board determines the voltage produced. The number of fuel cell boards in a stack determines the size of the total current of the fuel cell stack.

In embodiments, a fluid flow path is formed within a printed circuit board (PCB) layer such that the fluid flow path is routed or grooved within the PCB layer. In other words, the fluid flow path is formed without the routing or groove extending all the way through the PCB layer. As can be seen in FIG. 3a (112), FIG. 3b (111) and FIG. 6b (302), a fluid flow path or so-called depth route in the art, provide a flow path for gas or coolant within a single PCB layer, as opposed to requiring one layer to provide a flow path, and another to provide a sealing face as may be required in arrangements of the art. Depth routing to a depth of 1 mm may be applied in embodiments. Depth routing is not used with the PCBs described in the prior art. However here depth routing can be used because it enables more complex fluid paths while using fewer PCB layers, whilst also maintaining the sealing integrity of any one individual PCB board. Preferably, depth routing is where the whole PCB board is not routed through, i.e. only 10%, or only 20%, or only 30%, or only 40%, or only 50%, or only 60%, or only 70%, or only 80%, or only 90% of the depth of the PCB board is routed through. Preferably only 10% to 90% of the depth of the PCB board is routing through, preferably only 20% to 80% of the depth of the PCB board is routing through, preferably only 50% to 75% of the depth of the PCB board is routing through. This may also be referred to as depth drilling.

Preferably, the face of the second PCB layer adjacent to the anodes in the fuel cell board comprises the second flow channel, so that reducible fluid flows to the each or all of the anodes. The second PCB layer comprises means to conduct electrical current from one face of the second PCB layer to the other face of the second PCB layer.

When the inner face of the second PCB layer adjacent to the anodes is copper plated and in contact with the MEA, it allows conduction of current to the outer surface of the fuel cell board. This can in turn be in contact with means to carry this current away from the board.

Preferably, the fuel cell comprises a plurality of fuel cell boards. Each fuel cell board can be arranged such that the first PCB layer and the each or all of the cathodes of each fuel cell board face the second PCB layer and the each or all of the anodes of the adjacent fuel cell board. Each fuel cell board can be arranged such that the second PCB layer and the each or all of the anodes of each fuel cell board face the first PCB layer and the each or all of the cathodes of the adjacent fuel cell board. In these closed cathode configurations, the reactant air can be compressed, having increased pressure and so can be forced into a smaller space. This can supplied from a cathode inlet and down the manifold to each individual cathode via drilled holes. An anode can be supplied in a similar way, from a separate inlet and manifold to each individual anode via drilled holes.

In an embodiment, the fuel cell can comprise means to cool at least one fuel cell board. The means to cool the fuel cell boards can be at least one coolant plate, the coolant plate comprising at least one PCB, the PCB comprising a further/third fluid path, wherein the further/third fluid path carries a coolant fluid. The coolant plate can be arranged between the first PCB layer and the second PCB layer of the adjacent fuel cell board. The plate comprises means to conduct electrical current from one face of the coolant plate to the other face of the coolant plate. Coolant plates could have multiple different coolant fluid paths, of different sizes, shapes and/or dimensions, different coolant types, or fluids at different flow rates or different fluid temperatures. Coolants could be at different temperatures or different flow rates in different plates, or at different temperatures or at different flow rates in different flow paths within the same plate. This can address varying coolant need throughout a fuel cell.

Preferably, when multiple coolant plates are present in a fuel cell stack, each coolant plate may have different fluid paths, different sized, shaped or dimensioned fluid paths or be designed to carry different fluids, or different temperature fluids, or fluids with different flow rates. This can address varying coolant need throughout a fuel cell.

This coolant plate can act as a bipolar plate. The further/third fluid path can be routed into the PCB layer of this plate. The plate may comprise means to conduct electrical current from one face of the plate to the other face of the plate, for example plated through holes. This enables the contact of anodes and cathodes of adjacent modules.

Fuel cell stacks with these coolant plates are advantageous because they do not need to be open to input of coolant air, and are completely sealed to the atmosphere. Power density can be increased due to the lack of non-functional spacer elements and the ability to supply reactant gases at a higher pressure thus increasing power density and reactant distribution on the electrodes.

Preferably, the coolant plate may be laminated with or to the fuel cell board. Preferably, this is laminated to the second PCB layer, i.e. adjacent to the anode side of the MEA. Lamination of the coolant plate to the fuel cell board allows increased energy density because in this coolant plate there is just one layer of PCB. Further, sealing the coolant plate to the fuel cell board simplifies assembly of the fuel cell stacks, due to there being fewer components and fewer non-built in seals to the stack. This can be termed a Liquid Coolant Plate Module, and comprises an anode plate (first PCB layer) cathode plate (second PCB layer), MEA and a coolant plate all in a single board, plate, module or assembly. A plurality of these can form a fuel cell stack, as described herein.

Preferably, the coolant plate can comprises two PCB layers, and wherein the first layer comprises the further coolant flow field, wherein the first layer is thicker than the second layer, and wherein the second layer seals the flow field of the first layer. Preferably, the two PCB layers are laminated together with prepreg. Preferably, this coolant plate is not laminated to the fuel cell board, but is a separate plate.

Preferably, the face of the first PCB layer adjacent to the cathodes in the fuel cell board comprises the second flow channel, so that oxidisable fluid flows to the each or all of the cathodes. The first PCB layer comprises means to conduct current from one face of the first PCB layer to the other face of the first PCB layer.

In embodiments herein, the first or second PCB layers may be drilled in several hundred locations and copper plated to form an electrical path between the inner and outer faces of the PCB layers.

In a further embodiment, the fuel cell comprises a plurality of fuel cell boards and at least two spacers. Each fuel cell board is arranged such that the first PCB layer and the each or all of the cathodes of each fuel cell board face the first PCB layer and the each or all of the cathodes of the adjacent fuel cell board. Each fuel cell board is arranged such that the second PCB layer and the each or all of the anodes of each fuel cell board face the second PCB layer and the each or all of the anodes of the adjacent fuel cell board. The spacers separate adjacent stacked fuel cell boards and/or are at the top and/or the bottom of a stack of one or more fuel cell boards.

By stacking a plurality of fuel cell boards, the total output voltage of the fuel cell is increased proportionately. Moreover, by arranging the fuel cell boards such that the anode side of a fuel cell board faces the anode side of an adjacent fuel cell board, it is possible to arrange a coolant fluid path to direct coolant only to the space between the anodes.

Here the oxidisable gas flows only to the at least one cathode of the at least one fuel cell board. By arranging the third fluid path only adjacent the anode side of the fuel cell board and arranging the first fluid path only adjacent the cathode side of the fuel cell board, the coolant fluid flow is decoupled from the reactant fluid flow. In doing so, the coolant fluid flow may be controlled independently of the reactant fluid flow to have different flow rate, pressure, and/or composition as desired.

According to these preferred embodiments, at least one coolant fluid path is arranged only adjacent the anode side of the fuel cell board such that coolant fluid is directed only to the anode. In doing so, this coolant fluid is not directed to the cathode which could otherwise remove moisture from the cathode. Thus, humidity at the cathode can be maintained at a desired level in order to hydrate the electrolyte and maintain fuel cell efficiency.

Preferably, the fuel cell board comprises plated through holes to form an electrical connection between the at least one anode and at least one cathode, or anodes and cathodes, on the same fuel cell board.

Preferably, at least one of the spacers is an anode spacer, comprising at least one PCB layer and is a means to cool at least one fuel cell board. The anode spacer is located between the second PCB layers of the adjacent fuel cell boards. The anode spacer comprises at least one third fluid path arranged to carry coolant fluid. Here, the coolant fluid is air and wherein the fluid flow path is from the atmosphere outside of the fuel cell to the further fluid path arranged to carry coolant fluid.

Preferably, at least one of the spacers is a cathode spacer and comprises at least one PCB layer. The cathode spacer is located between the first PCB layers of the adjacent fuel cell boards. The anode spacer comprises at least one further fluid path arranged to supply an oxidisable fluid to the at least one first fluid path. Here, the oxidisable fluid is air and wherein there is a direct fluid flow path from the atmosphere outside of the fuel cell to the further fluid path arranged to supply an oxidisable fluid to the at least one first fluid path.

An ‘anode spacer’ can be used to give a gap where coolant air from the atmosphere can be supplied. A ‘cathode spacer’ cam be used to give a gap where reactant air from the atmosphere can be supplied. Spacers may be configured with an integrated coolant conduit defining fluid paths. They can be integrated reactant conduits defining at least one fluid paths for supplying a reactant fluid to the at least one fuel cell board, cathodes or anodes. Spacers may be configured without integrated conduits, but so that fluid flow is directed in the desired direction, for example by having entry and exit points so that pressurised air enters or leaves the spacers in the desired directions (e.g. perpendicular to entry). Spacers can have fluid entry and/or exit points to direct the fluid paths. Spacers could have multiple different fluid paths, of different sizes, shapes and/or dimensions or different coolant types. Fluids could be at different flow rates or different fluid temperatures in different spacers, or at different flow rates or temperatures in different flow paths within the same spacer. This can address varying coolant or reactant need throughout a fuel cell.

Preferably, when multiple spacers are present in a fuel cell stack, each spacer may have different fluid paths, different sized, shaped or dimensioned fluid paths or be designed to carry different fluids, or they may have fluids at different flow rates or different fluid temperatures. Multiple anode or multiple cathode spacers could be different from each other, as well as anode and cathode spacers being different from each other. This can address varying coolant or reactant need throughout a fuel cell.

An aspect of preferred embodiments provides a spacer as described herein.

In these designs it is not necessary to stack the anode of one fuel cell board next to the cathode of the next, adjacent fuel cell boards may have their anode sides (or cathode sides) facing each other, in which case spacers can be provided as there is no risk of the gases mixing. This results in a significant increase in packing density of the fuel cell as one gas flow can serve two fuel cell boards, reducing the number of seals, and increasing the power density. Repeat distances (i.e. the thickness of the combined fuel cell board and feed region) may be as low as about 0.2 mm. Hence a far higher volumetric power density of the fuel cell system is achievable. Further, the channels in the surface are easily formed for gas circulation and internal conduits are easily integrated into the spacer, allowing coolant and/or water to circulate and providing a cooling and water distribution system for the stack. Channels provided for the reactant gases and channels or conduits associated with the cooling and/or water distribution system are separate as discussed in more detail below

Preferably, the spacers have a means to conduct electrical current from on face of the spacer to the other face and wherein the means to conduct electrical current are substantially at only one at one end of the spacer.

Preferably, the fuel cell comprises multiple fuel cell boards, multiple anode spacers and multiple cathode spacers. The fuel cell may comprise a single fuel cell board or a plurality of fuel cell boards. In some embodiment, the or each fuel cell board may comprise a plurality of anodes and a plurality of cathodes arranged in pairs, and a plurality of electrical connectors configured to connect adjacent pairs of anodes and cathodes through the at least one ion permeable membrane. By providing a fuel cell board with a plurality of anode-cathode pairs, the total output voltage of the fuel cell board is increased.

Preferably, the first PCB layer comprises multiple first fluid paths to supply the oxidisable fluid to the cathodes at multiple points across each or all cathodes of a single MEA. The multiple first fluid paths are channels or holes through the body of the first PCB layer. The parts of the first PCB layer with channels or holes not formed in the PCB layer are in contact with the cathodes to provide an electrically conductive path from the cathode through the first PCB layer. Here, the oxidisable fluid is air and wherein there is a fluid flow path from the atmosphere outside of the fuel cell to the further fluid paths arranged to supply air to the multiple first fluid paths

Preferably, at least 40% of surface area of the first PCB layer comprises channels or holes or wherein the ratio of surface area of the first PCB comprising channels or holes to surface area of the first PCB not comprising channels or holes is 60:40, and/or wherein there are at least 100 channels or holes in the first PCB layer to provide the fluid paths.

The multiple fluid paths can be in the form of multiple holes through the whole body of the plate to form the multiple first fluid paths to direct the oxidisable fluid to the cathodes at multiple points across each or all cathodes. The nature of the structure of the plate is so that the cathode(s) are exposed to the oxidisable fluid at multiple points and to ensure high level of reactivity. Open space above a cathode (‘fluid path’ or ‘channel’) serves to deliver reactant air and any unexposed space (referred to as a land herein) is making electrical contact to the cathode, to provide a conductive path. Holes are highly manufacturable and these designs have as much area open as possible without compromising the compression of the land on to the cathode gas diffusion layer.

Preferably, the fuel cell board comprises a further PCB layer on top of the first PCB layer to seal the MEA. This cathode cap layer is a relatively thin layer of PCB (i.e. the cap layer is thinner than the first PCB layer) and provides an advantage when manufacturing the boards, as it seals the cathode and the MEA after MEA lamination in the PCB. The MEA may need to be sealed if there is a post-processing step for this fuel cell design, such as the process of making plated through holes (PTHs) to be plated through the module. PTHs can be formed using a dip process in a copper solution (a plating process) which can irreversibly damage the MEA integrity. The cap layer is in place for the PTH formation process, to protect the MEA from such an electrolyte plating solution. The cap layer encases the MEA components. Once the PTHs are made, the cap layer can then be routed to expose the open cathode below it. Having the PTHs through the MEA, thus reduces the stack size and reduces cost of production per fuel cell board, removing the need for an area around the MEA area to provide the cell interconnects.

The MEA has an optimal compression level under the lands (the areas which are pressed down upon by the flow field plates, which enables the electrical contact). This is a trade-off between contact resistance (the higher the compression the better) and the gas diffusion properties (the lower the better). By selecting appropriately thick and multiple layers of prepreg, compression applied to the MEA can be controlled, optimising MEA operation. Furthermore, the preferable addition of PTHs near these areas ensures there is mechanical strength maintained in these areas under thermal and mechanical stresses caused during operation

Preferably, the plurality of first fluid paths are arranged to direct the oxidisable fluid in a direction substantially perpendicular to the direction in which the third fluid path or multiple third fluid paths directs the coolant fluid. It is therefore possible to further decouple the effects of the coolant fluid flow from the reactant fluid flow.

Preferably, the plurality of first fluid paths are arranged to direct the oxidisable fluid into the fuel cell board in a direction substantially opposite to the direction in which the third fluid path or multiple third fluid paths direct the coolant fluid into the fuel cell board. The third fluid paths or multiple third fluid are arranged so that after input of the coolant fluid into the fuel cell board the coolant fluid leaves the fuel cell board in at least one direction substantially perpendicular to the direction it was directed into the fuel cell board. The first fluid paths are arranged so that after input of the oxidisable fluid into the fuel cell board the oxidisable fluid leaves the fuel cell board in at least one direction substantially perpendicular to the direction it was directed into the fuel cell board.

Preferably, the third fluid path or multiple third fluid paths are also arranged so that after input of the coolant fluid to the fuel cell board the coolant fluid leaves the fuel cell board in two different directions, both directions substantially perpendicular to the direction the coolant fluid was directed into the fuel cell board. The first fluid paths are also arranged so that after input of the oxidisable fluid to the fuel cell board the oxidisable fluid leaves the fuel cell board in two different directions, both directions substantially perpendicular to the direction the oxidisable fluid was directed into the fuel cell board. The fluid paths can also be arranged so that after input of the reactant fluid to the fuel cell board the used oxidisable fluid leaves the fuel cell board in two different directions, both directions substantially perpendicular to the direction the reactant fluid was directed into the fuel cell board.

Preferably, the plurality of first fluid paths are arranged to direct the oxidisable fluid into the fuel cell board in a direction substantially opposite to the direction in which the third fluid path or multiple third fluid paths direct the coolant fluid into the fuel cell board. The third fluid path or multiple third fluid paths are arranged so that after input of the coolant fluid into the fuel cell board the coolant fluid leaves the fuel cell board in at least one direction substantially opposite to the direction it was directed into the fuel cell board. The first fluid paths are arranged so that after input of the oxidisable fluid into the fuel cell board the oxidisable fluid leaves the fuel cell board in at least one direction substantially opposite to the direction it was directed into the fuel cell board. The fluid paths can be arranged to direct the coolant fluid into the fuel cell board from a first side of the fuel cell board towards a second side of the fuel cell board opposite the first side and return the coolant fluid to the first side to exit the fuel cell board from the first side.

Preferably, the third fluid path or multiple third fluid paths are arranged to direct the coolant fluid into the fuel cell board from a first side of the fuel cell board towards a second side of the fuel cell board opposite the first side and return the coolant fluid to the first side to exit the fuel cell board from the first side.

Preferably, the plurality of second fluid paths are arranged to direct the reactant fluid in a direction substantially perpendicular to a direction in which the plurality of first fluid paths direct the coolant fluid.

Preferably, wherein the plurality of second fluid paths are arranged to direct the reactant fluid into the fuel cell board in a direction substantially opposite to the direction in which the plurality of first fluid paths direct the coolant fluid into the fuel cell board. The first fluid paths are arranged so that after input of the coolant fluid into the fuel cell board the coolant fluid leaves the fuel cell board in at least one direction substantially perpendicular to the direction it was directed into the fuel cell board. The second fluid paths are arranged so that after input of the reactant fluid into the fuel cell board the reactant fluid leaves the fuel cell board in at least one direction substantially perpendicular to the direction it was directed into the fuel cell board.

Preferably, the first fluid paths are also arranged so that after input of the coolant fluid to the fuel cell board the coolant fluid leaves the fuel cell board in two different directions, both directions substantially perpendicular to the direction the coolant fluid was directed into the fuel cell board. The second fluid paths are also arranged so that after input of the reactant fluid to the fuel cell board the reactant fluid leaves the fuel cell board in two different directions, both directions substantially perpendicular to the direction the reactant fluid was directed into the fuel cell board.

Preferably, the plurality of second fluid paths are arranged to direct the reactant fluid into the fuel cell board in a direction substantially opposite to the direction in which the plurality of first fluid paths direct the coolant fluid into the fuel cell board. The first fluid paths are arranged so that after input of the coolant fluid into the fuel cell board the coolant fluid leaves the fuel cell board in at least one direction substantially opposite to the direction it was directed into the fuel cell board. The second fluid paths are arranged so that after input of the reactant fluid into the fuel cell board the reactant fluid leaves the fuel cell board in at least one direction substantially opposite to the direction it was directed into the fuel cell board.

Preferably, first fluid paths are arranged to direct the coolant fluid into the fuel cell board from a first side of the fuel cell board towards a second side of the fuel cell board opposite the first side and return the coolant fluid to the first side to exit the fuel cell board from the first side.

Preferably, an outlet from the first fluid path is connected to an exhaust to atmosphere, or preferably the outlet from the first fluid path is connected to an exhaust via a humidifier, such that the water produced in the fuel cell can be used to humidify the air going into the stack.

Preferably, the inlet to the second fluid path is connected to a hydrogen cannister, to supply hydrogen reactant to the anodes to act as a reducible gas in order to fuel the fuel cell operation. Preferably, the outlet of the second fluid path is connected to an exhaust to the atmosphere. Preferably, the outlet of the second fluid path is connected to an anode recirculation system. The anode recirculation system comprises means to remove water (e.g. a water trap to remove accumulated water) and a hydrogen pump or orifice which increases pressure. This allows any unused hydrogen can be put back into the stack

Another aspect of preferred embodiments provides a method of decoupling coolant fluid flow in a fuel cell, the fuel cell preferably being any of the fuel cells described in the above embodiment with decoupled coolant and oxidisable gas air flow, the method may comprise providing at least one fuel cell board, the or each fuel cell board comprising at least one ion permeable membrane, at least one anode and at least one cathode; arranging the at least one anode and the at least one cathode on opposite surfaces of the at least one ion permeable membrane; and arranging at least one fluid path adjacent the at least one anode for supplying a coolant fluid to the at least one fuel cell board, such that the coolant fluid flows only to the at least one anode of the at least one fuel cell board. The method may involve the use of any of the fuel cells described herein.

Preferably, each fuel cell board described in any aspect of the invention described herein comprises a plurality of anodes and a plurality of cathodes, wherein the anodes and cathodes are arranged in pairs opposite each other the membrane.

Preferably, each fuel cell board described in any aspect of the invention described herein is connected to an electronic circuit to produce an electrical output, and wherein the connection between each fuel cell board and the electronic circuit is individually switchable.

Preferably, the means to conduct electrical current described in any aspect of the invention described herein comprises plated through holes

Preferably, the oxidisable fluid described in any aspect of the invention described herein is air and the reducible fluid is hydrogen gas.

Preferably, the fuel cell described in any aspect of the invention described herein has a power rating of between 8 W and 100 W. In alterative embodiments such as air cooled arrangements, a fuel call may have a power rating of up to 5 kW and for liquid cooled arrangements, power ratings around or above 110 KW are obtainable.

Preferably, the lamination is achieved by chemical bonding by heating layers of prepeg between the PCB layers under pressure and an increased temperature.

Use of an epoxy resin prepreg also maintains compression of the gas diffusion layer of the MEAs, a critical component in maintaining fuel cell performance as it provides a sufficiently low resistance electrical path without compromising distribution of reactant fluids.

Preferably, the MEAs described in any aspect of the invention described herein further comprise a catalyst.

Preferably, the fluid paths described in any aspect of the invention described herein are routed into the PCBs prior to copper plating.

Preferably, the PCBs described in any aspect of the invention described herein are at least partially coated with a passivating layer after copper plating.

Preferably, wherein the first and/or the second fluid paths described in any aspect of the invention described herein are serpentine.

Preferably, the connection between each fuel cell board in the fuel cell and an output line can be controlled by a switch mechanism such as a field-effect transistor (FET) switch, providing power handling and control directly at the cell. Each of these switches can be controlled by individual control lines. This can be by providing a switch on each fuel cell board.

In some embodiments, the at least one fuel cell board may comprise at least one electrical connector configured to connect the at least one anode to the at least one cathode through the at least one ion permeable membrane. Connecting the anode to the cathode with the electrical connector through the ion permeable membrane allows an electrical current to flow in a direction along the plane of the membrane. In some embodiments, at least one through-membrane electrical connector may connect the electrodes across the membrane in a region where an anode and a cathode at least partially overlap, and the at least one through-membrane electrical connector may for example be produced by a homogeneous chemical deposition process.

An aspect of preferred embodiments provides the use of any fuel cell described herein.

### BRIEF DESCRIPTION OF THE DRAWINGS

Embodiments of the present disclosure will now be described with reference to the accompanying drawings, in which:

FIG. 1 shows a schematic side view of a stacked fuel cell of the prior art;

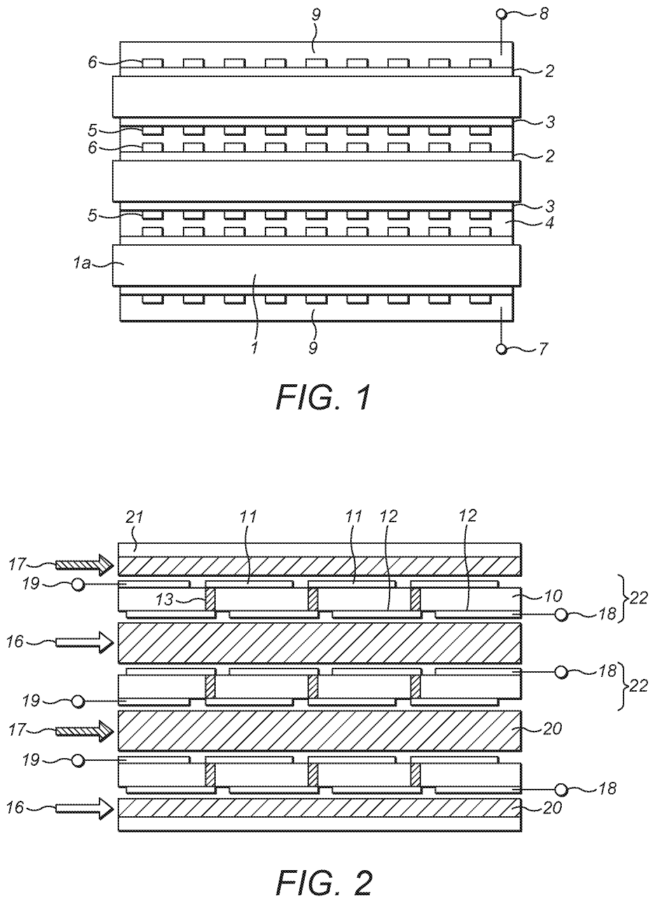

FIG. 2 shows a cross-section of a fuel cell of the prior art comprising a stack of fuel cell boards;

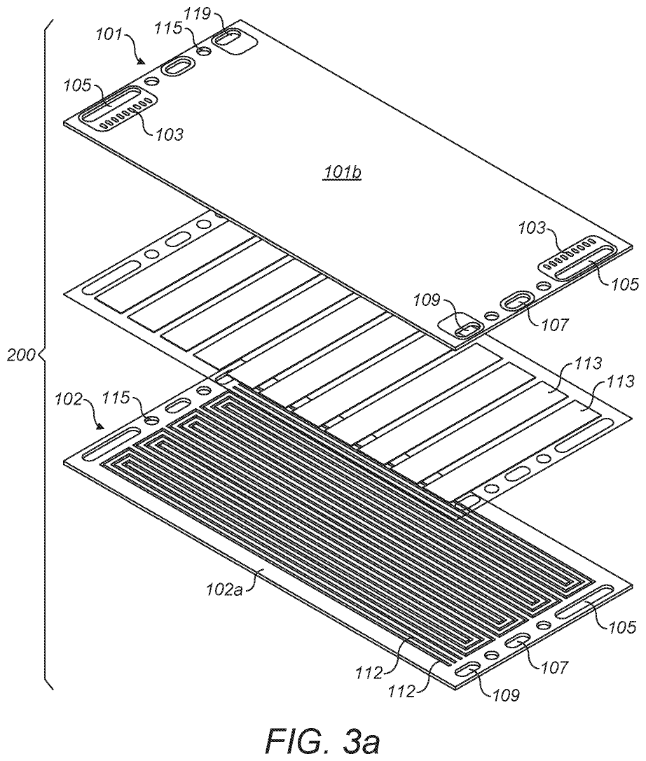

FIG. 3a shows an expanded embodiment of a fuel cell board of the present invention, FIG. 3b shows an alternative view of the same expanded embodiment of a fuel cell board of the present invention;

FIG. 4a shows one side of a cathode plate, FIG. 4b shows the other side of the same cathode plate;

FIG. 5a shows one side of an anode plate, FIG. 5b shows the other side of the same anode plate;

FIG. 6a one side of a coolant plate, FIG. 6b shows one of the two PCB layers which make up this coolant plant, FIG. 6c shows a side profile of the coolant plate;

FIG. 7 shows a fuel cell board of an embodiment;

FIG. 8 shows a schematic of a fuel cell stack of an embodiment;

FIG. 9 shows a simplified schematic of the fuel cell board layers of an embodiment;

FIG. 10 shows a fuel cell of an embodiment;

FIG. 11a shows an expanded further embodiment of a fuel cell board of the present invention, FIG. 11b shows an alternative view of the same expanded embodiment of a fuel cell board of the present invention;

FIG. 12a shows an open cathode plate, FIG. 12b shows a fuel cell board of an embodiment from one side, FIG. 12c shows the other side of the same fuel cell board;

FIG. 13 shows a schematic of plated through holes in the MEA of an embodiment;

FIG. 14 shows a schematic of a fuel cell stack of an embodiment;

FIG. 15 shows a simplified schematic of the fuel cell board layers of an embodiment;

FIG. 16 shows a schematic of coolant and reactant fluid flows in a prior art bi-polar configuration;

FIG. 17 shows a schematic of coolant and reactant fluid flows according to an embodiment;

FIG. 18a shows a conventional fuel cell stack; FIG. 18b shows a fuel cell stack according to an embodiment; FIG. 18c shows a fuel cell stack according to an embodiment with how the air flow enters and leaves the fuel cell;

FIG. 19a shows a fuel cell stack according to an embodiment; FIG. 19b shows an alternative view of a fuel cell stack according to an embodiment; FIG. 19c shows a fuel cell stack according to an embodiment with how the air flow enters and leaves the fuel cell shown;

FIG. 20a shows a top view of a spacer; FIG. 20b shows a side view of a spacer; FIG. 20c shows the other side of the same spacer; FIG. 20d shows a top view of a spacer with the airflow shown in dotted lines FIG. 20e shows a top view of another spacer; and FIG. 20f shows the other side of the same other spacer;

FIG. 21a shows a fuel cell stack according to an embodiment; FIG. 21b shows an alternative view of a fuel cell stack according to an embodiment; FIG. 21c shows a fuel cell stack according to an embodiment with how the air flow enters and leaves the fuel cell shown;

FIG. 22a shows a top view of a spacer; FIG. 22b shows a top view of another spacer; and FIG. 22c shows a top view of a spacer with the airflow shown in dotted lines; and

FIG. 23 shows the experimental results of a comparison of fuel cells.

### DETAIL DESCRIPTION

Embodiments will now be described in detail with reference to the accompanying drawings. The same reference signs indicate the same or similar features in different figures and embodiment of the invention, although this is only for reference and is not limiting on the invention. In the following detailed description numerous specific details are set forth by way of examples, in order to provide a thorough understanding of the relevant teachings. However, it will be apparent to one of ordinary skill in the art that the present teachings may be practiced without these specific details.

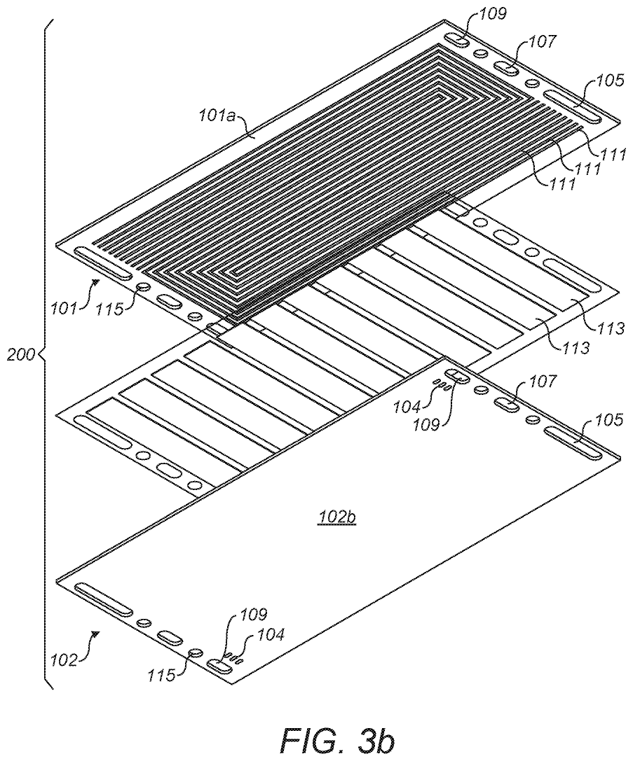

FIG. 3a is a schematic diagram of one view of an expanded fuel cell board 200 of an embodiment. Fuel cell board 200 is shown expanded for the purposes of this figure, to show the membrane electrode assemblies (MEAs) 113 separated from cathode plate 101 and anode plate 102.

Eleven cells or MEAs 113 are visible in a planar arrangement. These 11 cells or individual MEAs may be referred to as a singular MEA for all embodiments of the invention herein. Each MEA 113 comprises an ion permeable membrane, an anode and a cathode. In MEAs 113 of this embodiment all anodes are arranged on a first surface of the ion permeable membrane and all cathodes are arranged opposite the anodes on the other surface of the ion permeable membrane. Only a single membrane is present. In this embodiment MEAs 113 are laminated between the cathode plate 101 and anode plate 102, but are shown separated/expanded in this figure just to show their presence. The lamination process is described later.

This shows one embodiment of an MEA suitable for use for the embodiments described here. Other MEA designs, shapes, orientations would be known to a person of skill in the art and understood to be suitable with the present embodiments.

Cathode plate 101 and anode plate 102 are PCBs. In a fuel cell board 200 the cathode plate 101 and anode plate 102 are laminated together with the MEA 113, the MEA between the cathode plate 101 and anode plate 102 to form a fuel cell board 200. In FIG. 3a inner face 102a of anode plate 102 is visible. The inner faces of both cathode plate 101 and anode plate 102 (101a and 102a respectively) are plated with copper and routed with flow field 111, 112 designs, with a passivating ink screen printed over the flow field 111, 112 surfaces (on the inner faces 101a, 102a of both plates 101, 102) to prevent degradation. Flow fields 112 are visible on the inner face 102a and the anode plate in FIG. 3a (flow fields 111 are visible on the inner face 101a of the cathode plate 101 in FIG. 3b). Two flow field paths 112 are labelled in FIG. 3a and in total three flow field paths 112 are visible in FIG. 3a in the form of a serpentine loop traversing the face 102a of the plate 102. Multiple single flow fields 111, 112 make up the ‘flow field’ for each plate, and flow field(s) may be referred to in the singular or as a plurality throughout. Flow fields 111, 112 are shown to form serpentine loops traversing from one corner of the plates 101, 102 to the other corner of the same plate 101, 102.

In the specific embodiment displayed in FIGS. 3a and 3b, but also generally in all embodiments, flow fields are routed into the PCB to provide a path for the reactants (for example air, hydrogen) to be supplied to the cathodes and anodes. Oxidisable fluids flow only to each or all of the cathodes and reducible fluids flow only to the each or all of the anodes of each fuel cell board. Reference herein to ‘oxidisable fluids’ refers to fluids that will react at the cathode, for example air or oxygen. Reference ‘reducible fluids’ refers to fluids that will react at the anode, for example hydrogen.

The flow fields are channels routed into the surface of the PCBs, but are not routed through the whole body or volume of the board. They are just routed into one surface, no flow field or channels are found on the opposing face to the face into which the fields are routed. The present arrangement allows effective separation of the reactants for the anodes and the cathodes. For example, as visible in FIG. 3a, flow fields 112 on anode plate 102 are only routed into face 102a of anode plate 102, they are not routed through the whole body of the plate through to face 102b. Thus, no flow field is visible on the outer faces 101b, 102b of the cathode and anode plates 101, 102. When the boards are laminated the flow fields are located over the relevant part of the MEA 113 (the anode flow field over the anodes, the cathode flow fields over the cathodes), so as to supply the relevant reactant directly to the anodes and the cathodes. The pressure of the reactant fluids supplied ensures a reaction at the anodes and the cathodes. Recants will enter one side or corner of the plate and leave via the opposing or opposite side or corner of the plate.

Various flow field patterns and entry and exit points on a plate to the plate will be known to those of skill in the art. For example, flow paths can be serpentine, circular or just channels straight across a plate. Flow fields can enter and leave by the same side of a plate or opposing sides or corners of the plates. It is advantageous to have flow of reactants enter and leave opposite sides of the plate so that the reactant manifolds can easily be separated on opposing sides of a fuel cell.

The outer faces 101b, 102b of plates 101, 102 are also copper plated and are routed with the desired copper design. The plates are then drilled with holes for the various manifolds and flow fields, as described in more detail later.

After lamination, the outer surfaces 101b, 102b of the cathode pate 101 and the anode plate 102 have further holes 103, 104 drilled or routed. These holes 103, 104 provide access into their respective flow fields 111, 112 for reactant fluids (e.g. air and hydrogen) to be supplied from the manifold and back into the manifold, to and from (respectively) the flow fields 111, 112. Only one of the 9 holes 103 is shown labelled in FIG. 3a. For both plates 101, 102, one hole 103, 104 corresponds to one flow field 111, 112, each hole 103, 104, providing input/output for each individual flow field 111, 112. The number of holes corresponds to the number of flow fields 111, 112. No distinction is shown between the entry and exit holes 103, 104 in the figures.

On the cathode plate 101 reactant air is supplied and leaves through drilled holes 103 into/out of to the cathode flow fields 111. Cathode manifold 105 supplies compressed reactant air, and it is via cathode manifold 105 reactant air leaves cathode plate 101 and the fuel cell board 200 as a whole. The air comes from the atmosphere i.e. outside of the fuel cell, but it enters the fuel cell system via an air compressor (as opposed to a fan as may occur in later embodiments). This enables higher pressures of air to be achieved, although there is an increased parasitic energy cost to operate such a compressor over a fan.

Coolant manifold 107 and anode manifold 109 are also visible in FIG. 3a, and are also drilled or routed into the plates after lamination.

Generally, for all embodiments herein, manifolds of any appropriate size, dimension and shape supply and collect the reactants and coolants, or any other relevant substances, into and out of the inlets and outlets of fuel cell boards. Vertical channels up and down fuel cell stacks are connected to manifolds along the two opposed edges of the stack, which supply and collect the reactants, coolants etc. to and from boards.

The plates also have holes 115 drilled or routed for bolting holes, and/or alignment pins can be inserted into these. One of four per plate is labelled in FIGS. 3a and 3b.

FIG. 3b is a schematic diagram of an opposing view to FIG. 3a of the same expanded fuel cell board 200. Fuel cell board 200 is shown expanded for the purposes of this figure, to show membrane electrode assemblies (MEAs) 113 (here fully grey-scaled) separated from cathode plate 101 and anode plate 102.

Only inner face 101a of cathode plate 101 and outer face 102b of anode plate 102 are visible in FIG. 3b. The flow cathode flow fields 111 are visible on the inner face 101a of cathode plate 101 (four flow fields 111 are labelled in FIG. 3b but 9 flow field paths 111 are visible). A passivating ink is also screen printed over this flow field surface. In FIG. 3b the flow fields 112 for the anode plate 102 are not visible, it is on the not visible inner face 102a of the cathode plate 102.

On anode plate 102, reactant hydrogen is supplied and leaves through drilled holes 104 into/out of to the anode flow fields 112. Anode manifold 109 supplies reactant hydrogen, and it is via anode manifold 109 reactant hydrogen leaves anode plate 102 and the fuel cell board 200 as a whole. Coolant manifold 107 and cathode manifold 105 are also visible in FIG. 3b, also drilled into the plates after lamination.

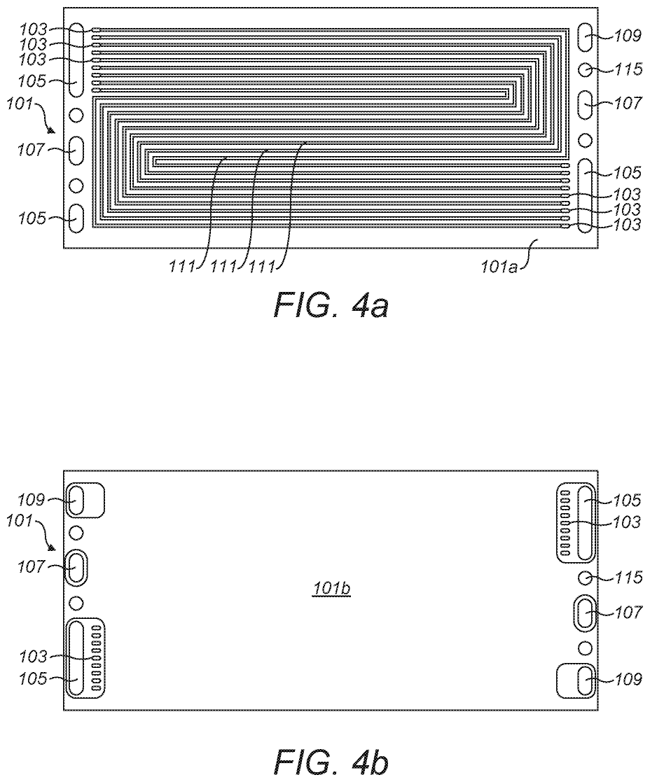

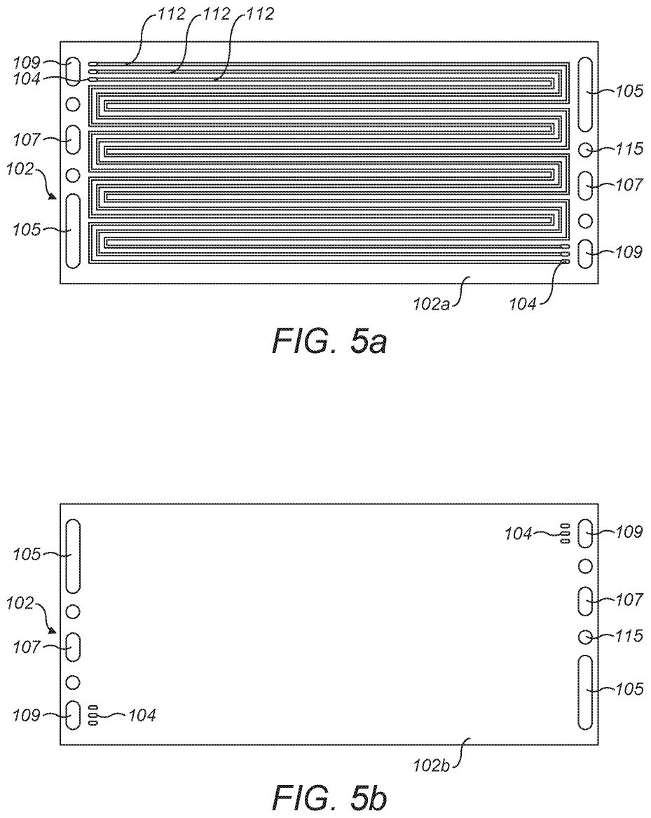

FIG. 4a shows the inner face 101a of the cathode plate 101 of this embodiment. Serpentine flow fields 111 are clearly visible, three of the 9 flow fields 111 are labelled, and the flow fields 111 are routed into the inner face 101a of the cathode PCB plate 101. Cathode manifold 105, coolant manifold 107 and anode manifold 109 are all visible. Reactant air is supplied and leaves through drilled holes 103 (three of 9 labelled) into/out of to the cathode flow fields 111 from/to cathode manifold 105. The plates also have holes 115 drilled or routed for bolting holes as described above, one of four per plate is labelled in FIGS. 4a, 4b, 5a and 5b.

FIG. 4b shows the outer face 101b of the cathode plate 101 of this embodiment. Holes 103, cathode manifold 105, coolant manifold 107, anode manifold 109 and holes 103 are all shown.

FIG. 5a shows the inner face 102a of the anode plate 102 of this embodiment. Serpentine flow fields 112 are clearly visible, three of the three flow fields 112 are labelled, routed into the inner face 102a of the anode PCB plate 102. Cathode manifold 105, coolant manifold 107 and anode manifold 109 are all shown. Reactant hydrogen is supplied and leaves through drilled holes 104 (one of three labelled) into/out of to the anode flow fields 112 from/to anode manifold 109.

FIG. 5b shows the outer face 102b of the anode plate 102 of this embodiment. Holes 104, cathode manifold 105, coolant manifold 107, anode manifold 109 and holes 104 are all shown.

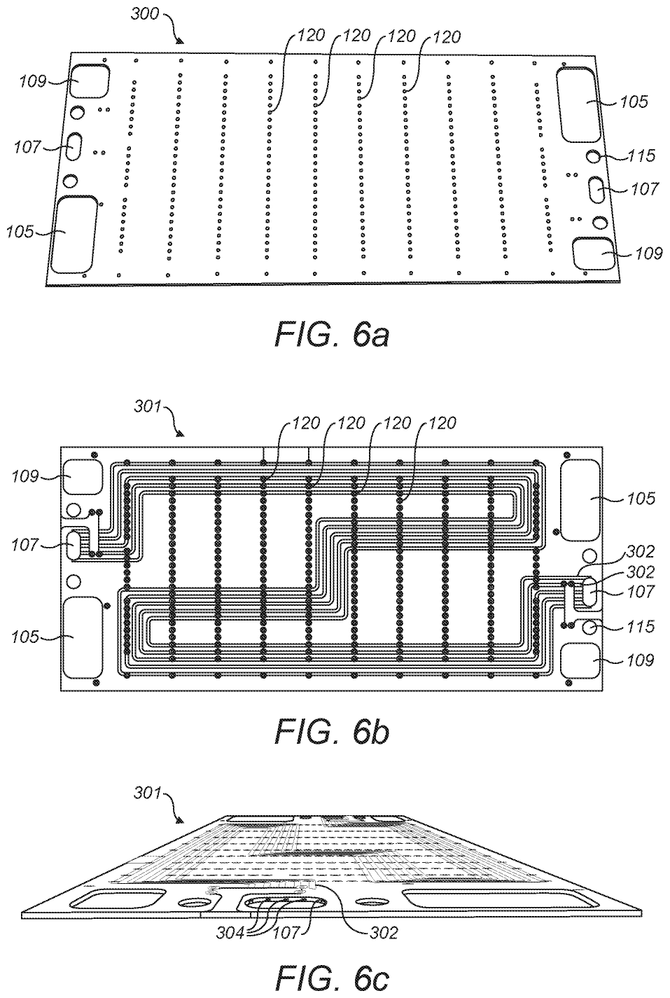

FIG. 6a shows one side of a coolant plate 300 of this embodiment of a fuel cell. In this embodiment this is a liquid coolant plate. Cathode manifold 105, coolant manifold 107, anode manifold 109 are all labelled. These manifolds line up with the equivalent manifolds on the fuel cell board 200. The coolant plate also has holes 115 drilled or routed for bolting holes as described above, one of four per plate is labelled in FIGS. 6a and 6b.

The coolant plate 300 is made of two PCB layers. FIG. 6b shows one of these two PCB layers 301, with inner face 301a shown. This is the thicker of the two PCB layers which together make up the coolant plate 300. Because it is copper plated and there are plated through holes 120 through the body of the plate, coolant plate 300 is conductive, acting as a bipolar plate between the adjacent cathode plates 101 and anode plates 102 of adjacent fuel cell boards 200. Plated through holes 120 are drilled around the flow fields 302 to provide conductive paths from one side of the plate 300 to the other. These enable electrical connection between anodes and cathodes of adjacent fuel cell boards. 4 exemplary plated through holes 120 are labelled, but ten rows of these can be seen along the coolant plate 300. In a multi-fuel cell board fuel cell stack of this embodiment the anode plates of one fuel cell board will be facing the cathode plate of the adjacent fuel cell board, and vice versa.

Flow fields 302 are routed into the inner face 301a of PCB layer 301, two of the 5 visible coolant flow fields of plate 300 are labelled. Layer 301 is bonded to a featureless second layer (not visible separately in FIGS. 6a-6c) which seals the flow fields 302 so that coolant entry/exit to/from the flow fields is only possible at the plate edge, as visible in FIG. 6c.

FIG. 6c shows a side profile of board 301 of coolant plate 300 showing just the PCB layer 301 with the flow fields, with one of the coolant flow fields 302 labelled of the 4 visible. Flow field input/output holes 304 are visible, with three of the 5 holes labelled. Equivalent input/output holes 304 are also found at the opposing ends of flow fields 302. Liquid coolant is supplied and leaves through these holes 304 into/out of to the coolant flow fields 104 from/to coolant manifold 107. In operation, coolant will be pumped into one side of the plate and will flow through the flow fields and out of the other side of the plate.

The coolant plate is linked to a means to supply coolant to the plate. This can involve, for example, a coolant being circulated around a coolant loop which requires a pump, a radiator and a stack cooling circuit (analogous to a car engine cooling loop with the stack replacing the engine). There can also be a small reservoir of coolant to account for small liquid losses over time. The coolant is stored in the reservoir and throughout the cooling circuit. The circuit takes heat from the stack, dissipates it through the radiator (which is assisted by a fan to dissipate the heat to the atmosphere), and is moved continuously by the pump during operation.

All coolants known to those of skill in the art would be suitable for the purposes of taking heat from the stack. For example, deionised water or a mixture of water and glycol to prevent freezing of the water can be used. Other suitable coolants are envisioned, and would be known to a person of skill in the art.

Coolant plates, within a single plate, could have multiple different coolant fluid paths, of different sizes, shapes and/or dimensions, or fluids at different flow rates or different fluid temperatures. Coolants could be at different temperatures or different flow rates in different plates, or at different temperatures or at different flow rates in different flow paths within the same plate. When multiple coolant plates are present in a fuel cell stack, each coolant plate may have different fluid paths, different sized, shaped or dimensioned fluid paths or be designed to carry different fluids. Different coolant plates could carry different temperature fluids, or fluids with different flow rates, depending on varying coolant need throughout the stack.

As well as acting as a conductive plate between the adjacent cathode plates 101 and anode plates 102 of adjacent fuel cell boards 200, the coolant plate 300 acts to cool the fuel cell boards either side of the plate 300. Coolant plates act to extract heat from the stack via coolant that is flown across the plate 300.

Overheating of the fuel cell stack can cause problems and cooling of stacks is typically required. This is generally achieved by supplying a coolant fluid (e.g. air or water) that circulates within the stack. Coolant and reactant fluids are typically supplied to the cathode in the same channel or flow. However, in all embodiments described herein, the coolant is not part of the same flow as the reactant to the cathodes (typically air, so air is the coolant as well as the cathode reactant). This separation of the coolant from cathode reactant is advantageous as it provides more control over the flow of reactant to the cathodes, the rate of which will not be determined by the rate of cooling airflow needed. It also allows improved control of cooling of the anodes.

Using a liquid coolant plate and a separate reactant source for the cathodes, i.e. not air pumped in from the atmosphere is especially advantageous for fuel cell stacks that operate at relatively higher energy densities. An increased energy density leads to an increased dissipation of heat, so a more efficient hear transfer means can be utilised. For example, a fluid with a higher heat capacity than air (i.e. water or a mixture of glycol and water) may be used as it has the ability to take the heat away from the stack. The use of a liquid coolant introduces a more complex system and more parasitic power losses in the form of a pump than an air cooled stack. Coolant cooled or air cooled stacks may be appropriate for different applications. Furthermore, it is also noted that for this embodiment because there is an increased energy density, although the reactant air (oxidant) for the cathodes comes from the atmosphere an air compressor is utilised. This is instead of a fan which may be used in later embodiments. This enables an increased energy density in the fuel cell stack, ensuring oxidant reactant rates can keep up with this. There is an increased parasitic energy cost to operate such a compressor over a fan, but this is less noticeable when energy density is increased.

A coolant plate may be laminated with or to the fuel cell board, but to the anode side of the fuel cell board (i.e. the second PCB layer, adjacent to the anode side of the MEA). This is for coolant plates with just one PCB layer, i.e. PCB layer 301 with coolant flow fields 302. Lamination of the coolant plate to the fuel cell board allows increased energy density because in this coolant plate there is just one layer of PCB. Further, sealing the coolant plate to the fuel cell board simplifies assembly of the fuel cell stacks, due to there being fewer components and fewer non-built in seals to the stack. This can be termed a Liquid Coolant Plate Module, and comprises an anode plate (first PCB layer) cathode plate (second PCB layer), MEA and a coolant plate all in a single board, plate, module or assembly. A plurality of these can form a fuel cell stack, as described herein.

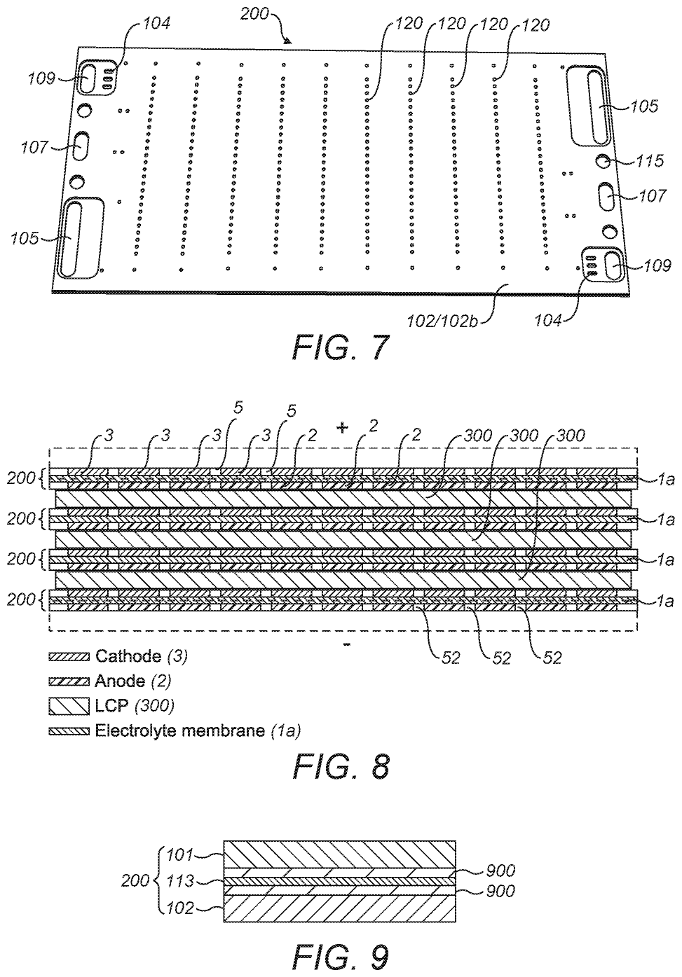

FIG. 7 shows a whole fuel cell board 200 of an embodiment, shown with the anode 102 plate face up (cathode plate 101 is face down and not visible). Outer face 102b of the anode plate 102 is labelled. Cathode manifold 105, coolant manifold 107, anode manifold 109 and holes 104 are all shown. One of four holes 115 drilled or routed for bolting holes as described above is labelled.

In FIG. 7 four exemplary plated through holes 120 are labelled, but ten rows of these can be seen along the outer face 102b of the cathode plate 102. Once the cathode plate 101, MEA 113 and anode plate 102 have been laminated, these plated through holes 120 (or vias) are drilled into the anode plate 102. Similar holes are drilled into the cathode plate 101, just not visible in FIG. 7. The plated through holes 120 through the anode plate 102 connect the inner copper surface 102a (not visible in FIG. 7) of the anode plate 102, which is in contact with the MEA 113 (not visible in FIG. 7), to the outer surface 102b of the anode plate 102 and thus the outer surface whole fuel cell board 200. In a fuel cell stack, the outer surfaces 101b, 102b of the fuel cell boards 200 are in contact with the liquid cooled plate 300. The liquid cooled plate 300 is conductive, so adjacent anodes and cathodes on adjacent boards 200 will be connected through these plated through holes 120 and the liquid cooled plate 300. There are no plated through holes though the electrolyte membrane of the MEA in these arrangements.

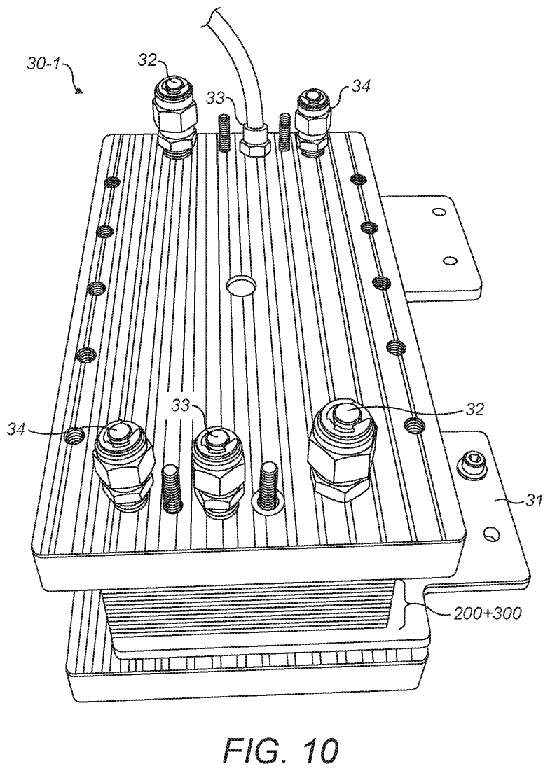

FIG. 8 shows a schematic of a fuel cell stack of this embodiment. Four fuel cell boards 200 are shown, four single cell plates 200, four cells in series. Cathode plates 101 and anode plates 102 are not separately shown in FIG. 8 but one of each is present in each fuel cell board 200 as described above (there would be four of each in a stack this size). In FIG. 8 three coolant plates 300 can be seen disposed between four fuel cell boards 200. Anodes 2 and cathodes 3 are shown, three of each are labelled in FIG. 8, each fuel cell board 200 has 11 anodes 2 and 11 cathodes 3 arranged in horizontal planes of only anodes 2 and only cathodes 3 in each horizontal plane. Anodes 2 are disposed opposite cathodes 3, with a single electrolyte membrane 1a between anodes 2 and cathodes 3. The layout of the anodes and cathodes in this embodiment is similar to that of a traditional fuel cell, because there is a single electrode in a plane. In typical bipolar fuel cells an MEA is sandwiched between bipolar plates to give a single cell at each layer. Bipolar plates are typically made with electrically conductive materials such as graphite or metals. Here, uniquely, traditional bipolar plates are replaced by the cathode boards 101, the anode boards 102 and the coolant plates 300, all here made of PCBs.

As described above, coolant plates 300 are conductive as they are copper coated and have plated through holes (not visible in FIG. 8, 120 in FIGS. 6a and 6b). As well as the cathode plate 101 and anode plate 102 not being shown, also not shown are the plated through holes 120 through the cathode plates 101 and anode plates 102 which electrically connect anodes 2 and cathodes 3 to the liquid coolant plates 300. Thus, the liquid coolant plates 300 connect adjacent anodes 2 and cathodes 3. In this embodiment, there are no plated through holes though the electrolyte 1a. By virtue of the conductive coolant plate 300, current does not need to cross the electrolyte layer, but moves laterally from anode to cathode parallel to the horizontal plane of electrodes. Consequently, no through-membrane connections are necessary for the current to flow.

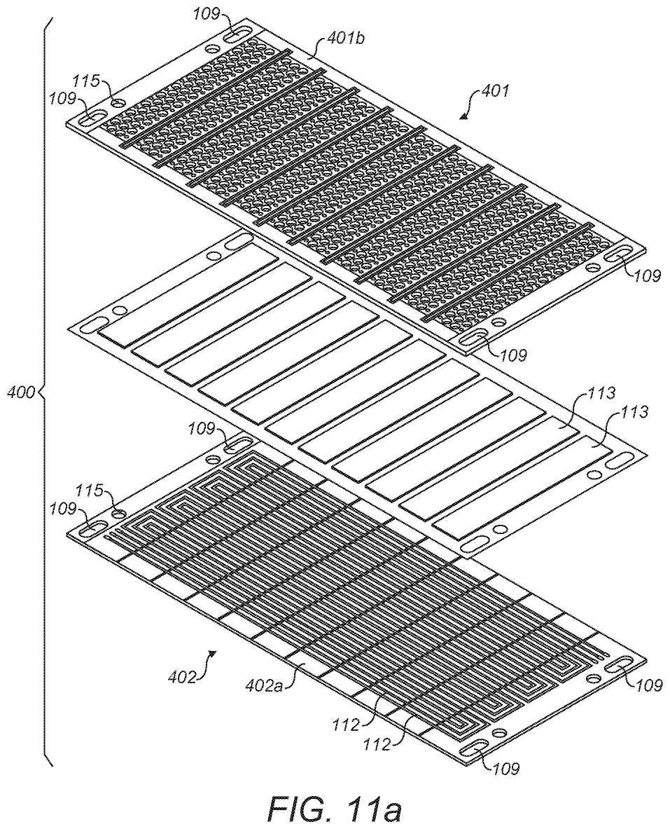

FIG. 9 shows a simplified construction schematic of a board of the present embodiment. Fuel cell boards are constructed by layering up of MEAs, PCB layers and an epoxy resin prepreg (herein ‘prepreg’). In construction of a fuel cell board 200 of this embodiment, the MEA 113 is sandwiched between two layers of prepreg 900, then the cathode and anode plates 101, 102 are laminated either side of those two layers of prepreg 900. These layers are laminated all together. Plated through holes 120 are then drilled into the anode 102 and cathode plates 101. After this is complete the final drills and routes expose the anode flow fields and cathode flow fields as well as drills for gas manifolding, bolting holes, and alignment pins are made.

Use of a sealing materials such as prepreg, and the use of PCB materials, ensures that the MEA is sealed from anything not deliberately directed to the components of the MEA by the channels in the PCB boards (e.g. anode and cathode plates) directly adjacent to the MEAs. This is an advantage of the PCB technology, it allows quick, simple and cheap construction of such structures. Use of lamination with for example an epoxy resin prepreg also maintains compression of the gas diffusion layer of the MEAs, an important component in maintaining fuel cell performance, providing a sufficiently low resistance electrical path without compromising distribution of reactant fluids.

Boards which are laminated with a specific lamination process, involving careful pre-cutting and alignment of materials, along with bespoke heating, cooling, pressure and washing cycles.

Once fuel cell boards 200 of this embodiment are constructed, they can be made into fuel cell stacks. These are modular and made of two components, the fuel cell boards 200 and the coolant plates 300. Stacks begin and terminate with an endplate which provides compression through the stack as well as sealed ports to connect fuel, oxidant, and coolant. Means to remove excess current can also be used at either end of the stack to take off the significantly high current when necessary. A stack can be built with a repetitive sequence of coolant plates 300 and fuel cell boards 200. After and before the two end plates, stacks begin and terminates with a coolant plate 300, acting to cool both ends of the stack. The stacks shown throughout are held together with bolts which also provide compression for the seals between modules, however any means to hold stacks together compressed, or any means to seal fuel cell boards, coolant plates, or modules together, and end plate types known in the art, may be utilised. Gaskets to seal manifolds or other parts of the fuel cell stack together can be used, if necessary, but may not be necessary in such a stack.

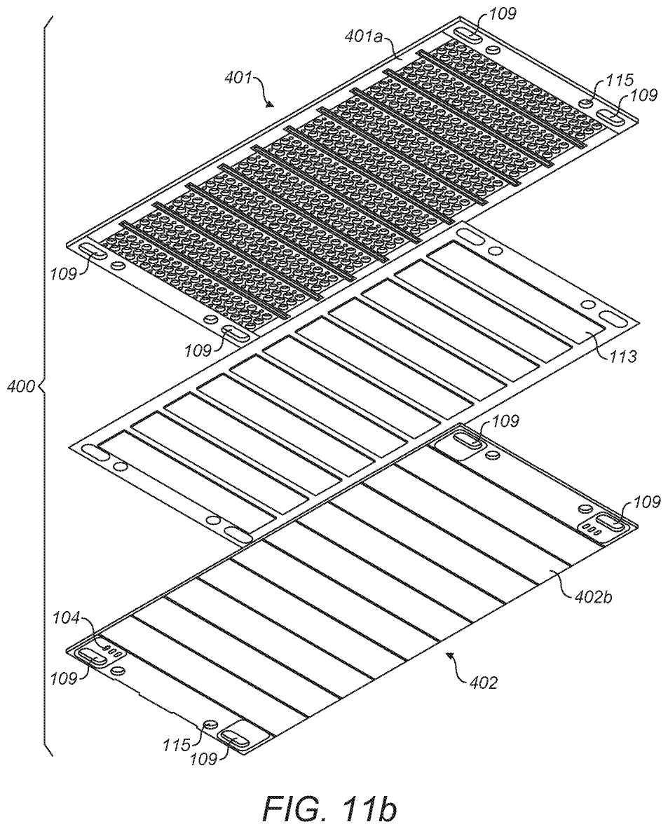

A fuel cell stack 30-1 of the of an embodiment is shown in FIG. 10. The fuel cell stack 30-1 is encased in a fuel cell casing with end plate 31 visible. Present in this embodiment are eleven liquid coolant plates 300 and ten fuel cell boards 200. As shown in FIG. 10, the fuel cell has two cathode inlet/outlets 32, two coolant inlet/outlets 33 and two anode inlets/outlets 34.

Cathode inlets 32 will be connected to a compressed air compressed air canister or an air compressor to supply compressed air to act as an oxidant to react at the cathodes in fuel cell operation. Cathode outlets 32 will be connected to an exhaust to the atmosphere. Sometimes cathode outlets 32 will be connected to an exhaust via a humidifier such that the water produced in the fuel cell can be used to humidify the air going into the stack. This is achieved via passing the incoming and outgoing fluids over a water permeable membrane.

Anode inlets 34 will be connected to a hydrogen cannister, to supply hydrogen reactant to the anodes to act as a reducible gas in order to fuel the fuel cell operation. Anode outlets 34 will be connected to an exhaust to the atmosphere or an anode recirculation system.

An anode recirculation system can comprise a water trap (to remove accumulated water) and a hydrogen pump or orifice which increases pressure such that any unused hydrogen can be put back into the stack.

Endplates 32 act to compress the fuel cell and to seal it, to prevent any fluid leakage in operation. Fuel cells are bolted together to ensure compression.

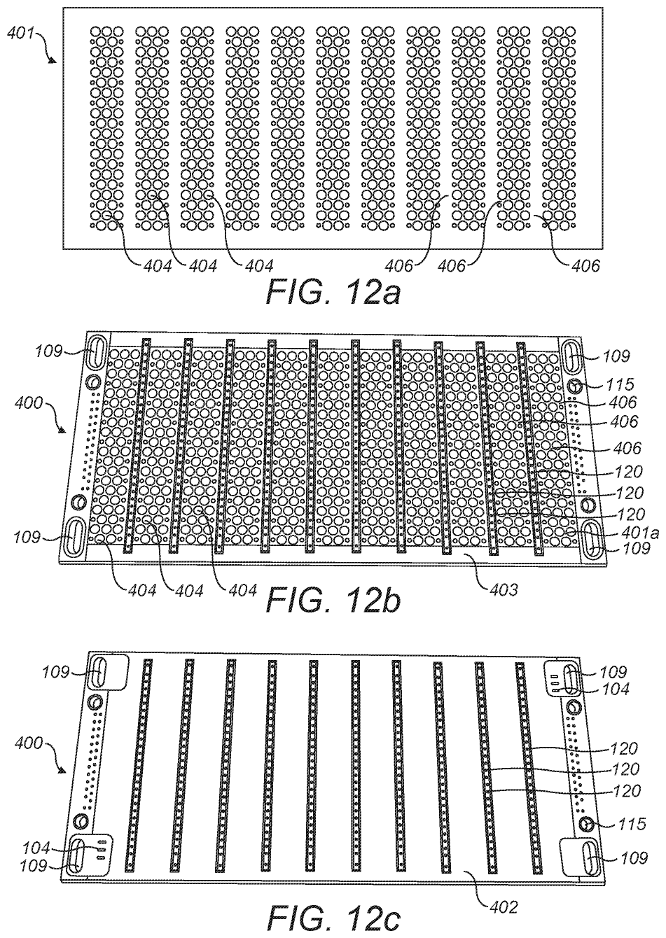

A further embodiment of the invention is shown in FIG. 11a and FIG. 11b. FIG. 11a is a schematic diagram of one view of an expanded fuel cell board 400 of an embodiment. Fuel cell board 400 is shown expanded for the purposes of this figure, to show the membrane electrode assemblies (MEAs) 113 separated from cathode plate 401 and anode plate 402.

Eleven cells or MEAs 113 are visible in a planar arrangement. In the earlier described embodiment, each MEA 113 comprises an ion permeable membrane, an anode and a cathode. In MEAs 113 of this embodiment all anodes are arranged on a first surface of the ion permeable membrane and all cathodes are arranged opposite the anodes on the other surface of the ion permeable membrane. Only a single membrane is present. In this embodiment MEAs 113 are laminated between the cathode plate 401 and anode plate 402, but are shown separated/expanded in this figure just to show their presence. The lamination process is described elsewhere.

Cathode plate 401 and anode plate 402 are PCBs. In a fuel cell board 400 the cathode plate 401 and anode plate 402 are laminated together with the MEAs 113, the MEAs 113 between the cathode plate 401 and anode plate 402 to form a fuel cell board 400. In FIG. 11a inner face 402a of anode plate 402 is visible. The inner faces of both cathode plate 401 and anode plate 402 (401a and 402a respectively) are plated with copper and here only the anode plate 402 is routed with a flow field 112 like designs, as described in the earlier embodiment of the invention. The cathode plate 401 has an alternative flow field design, consisting of many drilled holes in the face of the plate, as described later. Both plates 401, 402 have a passivating ink screen printed over the inner faces 401a, 402a of both plates 401, 402 to prevent degradation.

Flow fields 112 are visible on the inner face 402a and the anode plate in FIG. 11a. Two flow field paths 112 are labelled in FIG. 11a and in total three flow field paths 112 are visible in FIG. 11a in the form of a serpentine loop traversing the face 402a of the plate 402. Multiple single flow fields 112 make up the ‘flow field’ for the plate 402 and are shown as serpentine loops traversing from one corner of the plates 402 to the other corner of the same plate 402. Anode flow field provides a path for the reactant gas to be supplied to the anodes of MEA 113, as described earlier. Flow fields 112 on anode plate 402 are only routed into face 402a of anode plate 402, they are not drilled through the whole body of the plate through to face 402b. Thus, no flow field is visible on the out faces 402b of the anode plate 402. The outer faces 401b, 402b of plates 401, 402 are also copper plated and are routed with the desired copper design.

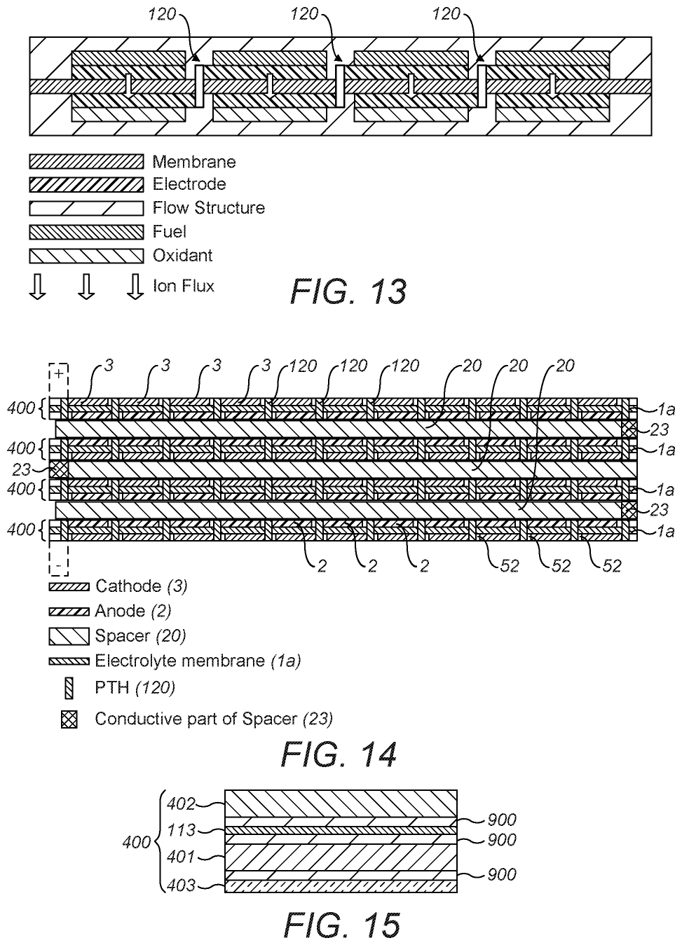

The holes are drilled or routed through the whole body of the cathode plate 401 as to expose the MEA 113 below the plate to the open atmosphere when the fuel cell board is laminated. Multiple holes can be seen drilled into the PCB. This creates multiple open spaces, channels or flow fields in the plate 401, which will expose the cathode below in the MEA 113 to the oxidisable fluid directed over the cathode plate 401, delivering the oxidisable fluid to the cathodes. Areas not drilled (herein “land”) make electrical contact with the cathodes below, providing an electrically conductive path from the cathode. The structure of this plate is described in more detail in relation to FIG. 12a.

Anode manifolds 109 are also visible in FIG. 11a and are drilled or routed into the plates after lamination. In this embodiment there is no cathode manifold because reactant air is supplied to the cathodes in a manner described later-via spacers. In this embodiment there is also no coolant manifold, because the anode plate is cooled with an anode spacer, as described later. This simplifies the design and allows more variety in the design of anode manifold and anode reactant distribution throughout a fuel cell stack.

After lamination, the outer surface 402b of the anode plate 402 has holes drilled or routed to provide access into the flow fields 112 for the reactant fluid to be supplied from the anode manifold 109 and back into the manifold 109, to and from the flow field 112.

The plates also have holes 115 drilled or routed for bolting holes, and/or alignment pins can be inserted into these. Only one of the eight in FIG. 11a is labelled, on plate 402.

Cathode plate 401 has a cap layer laminated over the top of the plate, not actually visible or distinguishable from the cathode plate 401 in the Figures. The top and bottom of the cap layer have copper features etched into the surface but are otherwise featureless. The cathode cap layer is a thin layer of PCB, which seals the cathode after MEA lamination in the PCB. The MEA needs to be sealed because there is a post-processing step for these fuel cell plates requires plated through holes to be plated through the module. The plated through holes are described later, but are achieved with a dip process in a copper solution which the MEA cannot be exposed to. Once the plated through holes are made, the cap layer can then be routed to expose the open cathode below it.

FIG. 11b is a schematic diagram of an opposing view to FIG. 11a of the same expanded fuel cell board 400. Fuel cell board 400 is shown expanded for the purposes of this figure, to show membrane electrode assemblies (MEAs) 113 (here fully grey-scaled) separated from cathode plate 401 and anode plate 402.

Only inner face 401a of cathode plate 401 and outer face 402b of anode plate 402 are visible in FIG. 11b. The many-hole pattern of the cathode flow field is visible on the inner face 401a of the cathode plate 401, as well as the outer face 401b visible in FIG. 11a. This is because the holes pass through the whole body of the cathode plate 401, so as to provide a flow path of air through the whole plate 401.

A passivating ink is also screen printed over this flow field surface. In FIG. 11b the flow fields 112 for the anode plate 402 are not visible, it is on the not visible inner face 402a of the cathode plate 402.

On anode plate 402, reactant hydrogen is supplied and leaves through drilled holes 104 into/out of to the anode flow fields 112. Anode manifold 109 supplies reactant hydrogen, and it is via anode manifold 109 reactant hydrogen leaves anode plate 102 and the fuel cell board 400 as a whole. This is similar to the embodiment described earlier.

FIG. 12a shows a simplified schematic of the cathode plate 401 (open cathode plate) of this further embodiment. This cathode plate 401 is a PCB which is routed or drilled with a desired flow field pattern. The holes are drilled or routed through the whole body of the cathode plate 401 as to expose the MEA 113 below the plate to the open atmosphere when the fuel cell board 400 is laminated. Here multiple holes 404 (just three labelled in FIG. 12a) can be seen drilled into the PCB. This creates multiple open spaces, channels or flow fields in the plate 401, which will expose the cathode below in the MEA 113 to the oxidisable fluid directed over the cathode plate 401, delivering the oxidisable fluid to the cathodes. In this embodiment the oxidisable fluid is air. Areas not drilled 406 (herein “land”) make electrical contact with the cathodes below. Three areas of land 406 are labelled in cathode plate 401 in FIG. 12a, but many more are visible. Any not open area (i.e. flow fields 404) is land 406. This land 406 provides an electrically conductive path from the cathode. A passivating ink is screen printed on the inner layer of the flow field surface to prevent degradation.

Generally, there are multiple designs of this open cathode plate that are appropriate, the drilling or routing through the whole body of the PCB plate to create the flow fields or channels could be in any pattern or design which exposes the MEA below. In order to conduct electrons away from the cathode, there must be some “land” or contact with the MEA in multiple places below. The more exposed to reactant air the MEA is, the more reaction can take place at the MEA.

However, if there were too many channels or the MEA was too open, then there would be too little contact with the cathodes and a lack of compression of the MEA with a potentially poor electrical conduction away from the MEA. In embodiments herein, a minimum of 40% of the surface area of the open cathode plate can be open or channels, a minimum of 50% of the surface area of the open cathode plate can be open or channels, or minimum of 60% of the surface area of the open cathode plate can be open or channels. The ratio of flow channel (i.e. open PCB, holes) to land or PCB which contacts the MEA can be between 40:60 (40/60) and 60:40 (60/40). Preferably, the channel to land split for a cathode is 60:40 (or 60/40). A minimum of 100 individual holes or channels can be provided on a cathode plate to create a minimum of 100 channels, flow field, or access points for reactant to pass through the cathode plate, or in some embodiments a minimum of 200 channels are provided, or a minimum of 400 channels are provided, or a minimum of 600 channels are provide, or a minimum of 800 channels are provide, or a minimum of 1000 channels are provide, or a minimum of 1200 channels are provided.

Using drilled holes through the whole body of the plate means that the open cathode plates are easily, quickly and cheaply manufacturable and having at least 40% to 60% open area allows for a high reaction rate at the cathodes without compromising the compression of the land on to the cathode.

FIG. 12b shows a fuel cell board 400 of the same embodiment. The cathode side of the module/board is facing upwards, so the cathode plate 401, cap layer 403 and inner face of the cathode plate 401a are facing upwards. The cap layer 403 is laminated over the cathode plate 401. As in FIG. 12a, multiple holes 404 (just three labelled in FIG. 12b) can be seen drilled into the cathode plate 401 and some land areas not drilled 406 (just three labelled in FIG. 12b) are also visible. The four anode manifolds 109 running through the plate 401 are also labelled, which in this embodiment are located in the four corners of the board 400. This embodiment of the invention has 4 anode manifolds because four are needed to enable the anode-anode-cathode-cathode plate arrangements of these stacks, as described herein.

This consequentially halves the total pressure drop through the manifold of this embodiment, compared to an embodiment with only two anode manifolds.

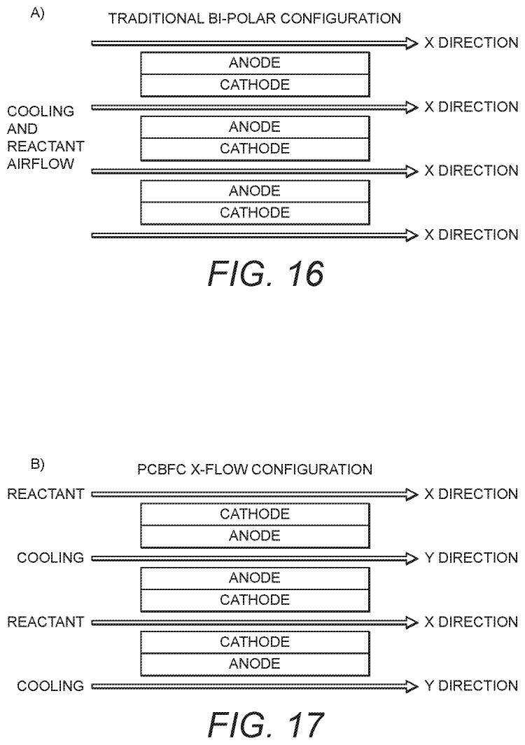

In FIG. 12b four exemplary plated through holes 120 are labelled, multiple rows of these can be seen along the open cathode plate 401. Once the open cathode plate 401, cap layer 403, MEA 113 and anode plate 402 have been laminated, these plated through holes 120 (or vias) are drilled into the board 400. These form an electrical connection between adjacent cathode and anodes in the same board, as demonstrated in FIG. 13 (described later). These holes go through the electrolyte membrane of the MEA 113, unlike in the earlier described embodiments. These holes go through the whole body of the board 400, unlike some of the other embodiments described herein. The plated through holes 120 also connect the MEA to the outer copper layer of the board 400. This is then in contact with the adjacent spacer, as described later.

FIG. 12c shows a fuel cell board 400 of the same embodiment. The anode side of the module/board is facing upwards, so the anode plate 402 and outer face of the anode plate 402b are visible. Three exemplary plated through holes 120 are labelled, multiple rows of these can also be seen along the anode plate 401. Anode manifold 109 and holes 104 are shown.

FIG. 13 shows how the plated through holes 120 form an electrical connection between adjacent cathode and anodes in the same board. Each anode is in electrical contact with the next cathode without shorting any cells.

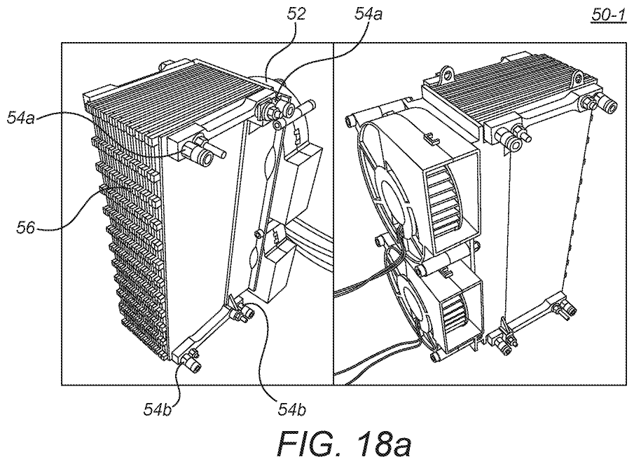

FIG. 14 shows a schematic of a fuel cell stack of this embodiment. Four fuel cell boards 400 are shown. Cathode plates 401 and anode plates 402 are not shown in FIG. 14 but one of each is present in each fuel cell board 400 as described above. In FIG. 14 three spacers 20 can be seen disposed between the four fuel cell boards 200. These would be two anode spacers and one cathode spacer, and their structure and the function is described later. Anodes 2 and cathodes 3 are shown, three of each are labelled in FIG. 14, each fuel cell board 400 has 11 anodes 2 and 11 cathodes 3 arranged in horizontal planes of only anodes 2 and only cathodes 3 in each horizontal plane. Anodes 2 are disposed opposite cathodes 3, with a single electrolyte membrane 1a between all anodes 2 and cathodes 3 of a single board 200. This layout of the anodes and cathodes in this embodiment is unlike that of a traditional fuel cell, 11 cells are created in each fuel cell board 400, because of the connection formed between caused by the plated through holes 120. Further, here, no bipolar plate made with electrically conductive materials such as graphite or metals is found between fuel cell boards 400. Instead, spacers 20 are found between boards.

Here, spacers 20 create electrical paths between adjacent boards. As visible in FIG. 14, the spacers 20 are conductive on one side only, the conductive part of the spacer is highlighted 23. The spacers are copper plated along their edge. In these embodiments the current will “zigzag” up/down and across a stack of multiple fuel cell boards 400 in order to put all the cells in series. This open cathode design has 11 cells in series in a planar arrangement, thus only one side needs to be conductive.

The cathode spacers act in place of the coolant plates 300 of the earlier described embodiments, as they can direct a coolant airflow around these stacks. Their design and functions are described in more detail later on.

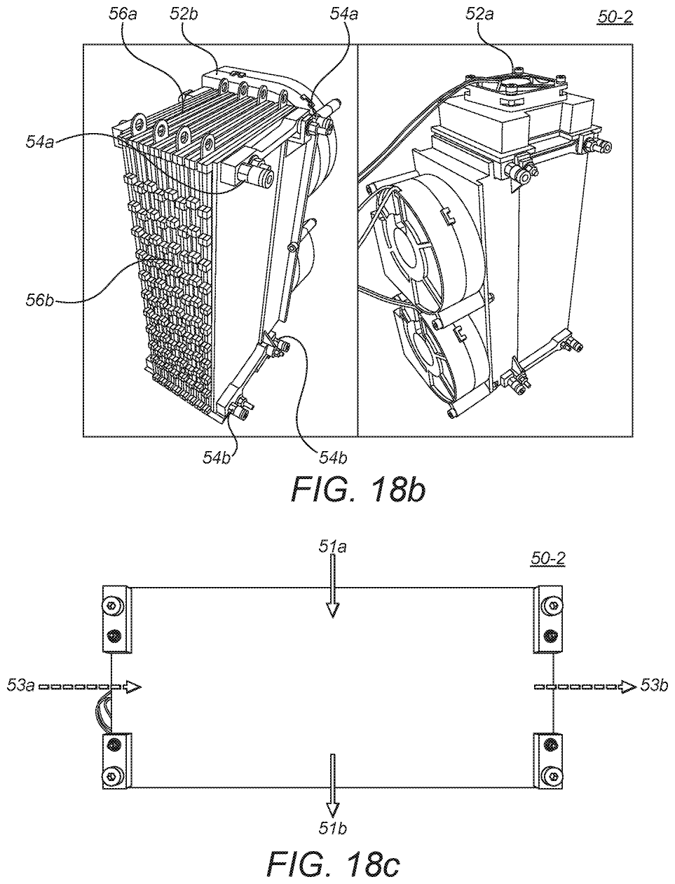

FIG. 15 shows a simplified construction schematic of a board of the present embodiment in the earlier described embodiments, fuel cell boards 400 are constructed by layering up of an MEAs, PCBs and prepreg. In construction of a fuel cell board 400 of this embodiment, the MEA 113 is sandwiched between two layers of prepreg 900, then the cathode and anode plates 401, 402. Another layer of prepreg 900 is then located between the cap layer 403 and the cathode plate 401. These layers are laminated together. Plated through holes 120 are drilled into the boards 400 after they have been laminated together. After this is complete the final drills and routes expose the anode flow fields and cathode flow fields as well as drills for gas manifolding, bolting holes, and alignment pins are made. These are manufactured in the same way as the embodiments described above, e.g. in relation to FIG. 9, just with an additional cap layer 403.

Once fuel cell boards 400 of this embodiment are constructed, they can be made into fuel cell stacks. These are modular and made of three main PCB components, the fuel cell boards 400, the anode spacers and the cathode spacers, detailed later.

Stacks begin and terminate with an endplate which directs air around the final modules in a stack. After the end plate, the stacking sequence is firstly cathode spacer with gaskets, then fuel cell board 400 with the cathode plate 402 face down, then an anode spacer with gaskets, then another module 400 with the cathode plate 402 face up. This sequence can be repeated indefinitely, terminating on either type of spacer, on top of a second end plate is placed. As described above, the spacers are conductive on one side only, so the current zigzags across the stack in order to put all the cells in series. The stack is held together with bolts, which also compresses the seals between modules in place. The stacks shown throughout are held together with bolts which also provide compression for the seals between modules, however any means to hold stacks together compressed, and end plate types known in the art, may be utilised. The advantages of using PCB spacers and the ability to seal the fuel cell stacks is described above.

In conventional fuel cells the current flows in a direction perpendicular to the plane of a fuel cell board, from the anode of one fuel cell board to the cathode of a next adjacent fuel board enabled by bi-polar plates or PCB coolant plates disposed between adjacent fuel cell boards. As such, the fuel cell boards are stacked with the anodes of one fuel cell board facing the cathodes of an adjacent fuel cell board in an anode-cathode-anode-cathode configuration.

However, in the present embodiments (e.g. those described in FIGS. 11 to 15), electrical current flows in a direction along the plane of a fuel cell board enabled by the through-membrane electrical connections. There is, therefore, no requirement for direct electrical contact between the fuel cell boards of a stack. As such, the fuel cell boards are stacked such that adjacent fuel cell boards have their anode sides (or cathode sides) facing or opposing each other in an anode-anode-cathode-cathode configuration.

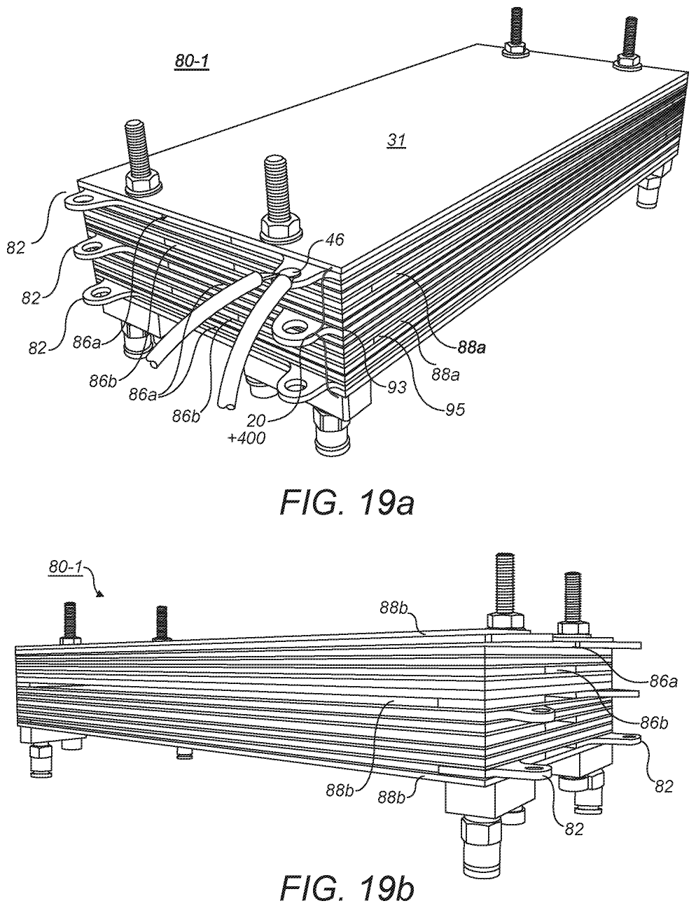

A coolant fluid flow is often required to remove excess heat from within a fuel cell stack, while an oxidisable reactant fluid flow is required at the cathodes to maintain reactions. When fuel cell boards are stacked in an anode-cathode-anode-cathode configuration, a coolant fluid flow can only be circulated in combination with a reactant fluid flow, as both anodes and cathodes would lie in the space between two adjacent fuel cell boards, as shown in FIG. 16. However, fuel cells require moisture and humidity to enable good conductivity of ionic pathways to allow them to operate efficiently. A large coolant fluid flow rates removes much of the moisture produced by the reactions in the fuel cell, which reduces fuel cell efficiency and impact the performance of the fuel cell.

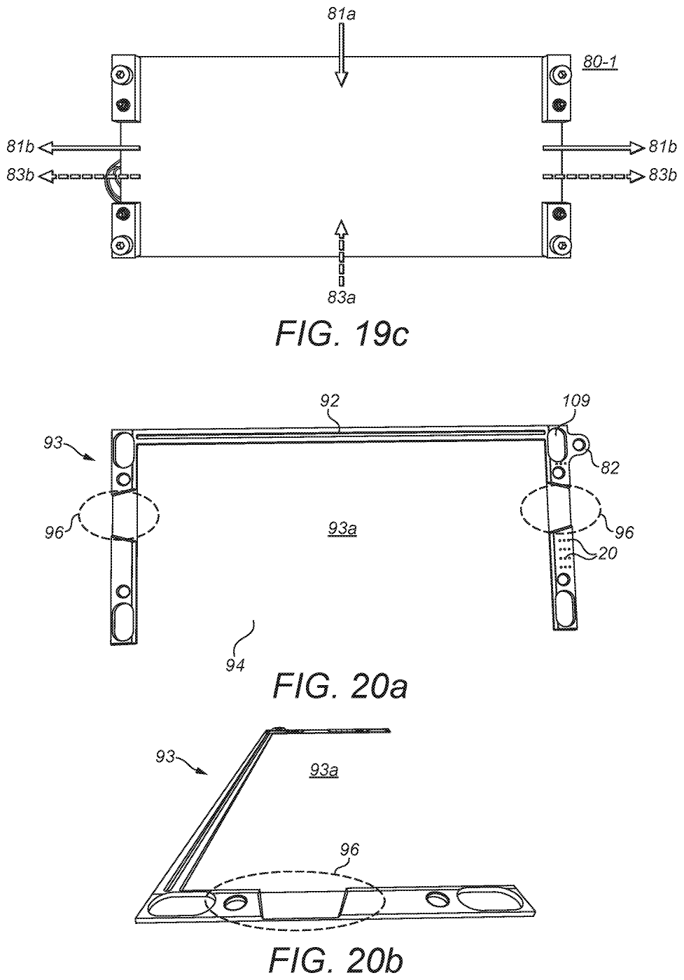

In the present embodiments, an anode-anode-cathode-cathode configuration (see FIG. 14) enables the coolant and reactant fluid flow to be decoupled in a fuel cell. As shown in FIG. 17, the configuration enables alternating gaps between the anodes of two adjacent fuel cell boards and the cathodes of two adjacent fuel cell boards. As such, coolant fluid can be directed only to the gaps between anodes and reactant fluid can be directed to the gaps between cathodes.

In a compressed fuel cell of the embodiments described here, the gaps between the two anode plates of two adjacent fuel cell boards and between the two cathode plates of two adjacent fuel cell boards in these embodiments are maintained by the spacers mentioned above and described herein.

In these arrangements, the coolant fluid and the reactant fluid that flow through each of the alternating gaps can be supplied perpendicular to one another, which further decouples the effects of the coolant and reactant fluid on the fuel cell. As can be seen in FIG. 17, the present arrangement allows fluid to be supplied from two directions (x and y). Thus, according to these embodiments, a coolant fluid flow can be supplied to the anodes in the y-direction to maintain a desired fuel cell temperature, while a reactant fluid flow can be supplied separately to the cathodes in the x-direction to maintain the reaction in the fuel cell. In doing so, the coolant fluid can be supplied at a much higher flow rate than that of the reactant fluid, such that excess heat can be removed effectively while retaining humidity around the cathodes at a desired level to maintain fuel cell efficiency. Moreover, the present arrangement is able to reduce the parasitic power requirement for the fuel cell system in a variety of operating conditions. For example, in hot conditions, the cooling requirement is lowered by the enhanced retention of water on the cathodes.

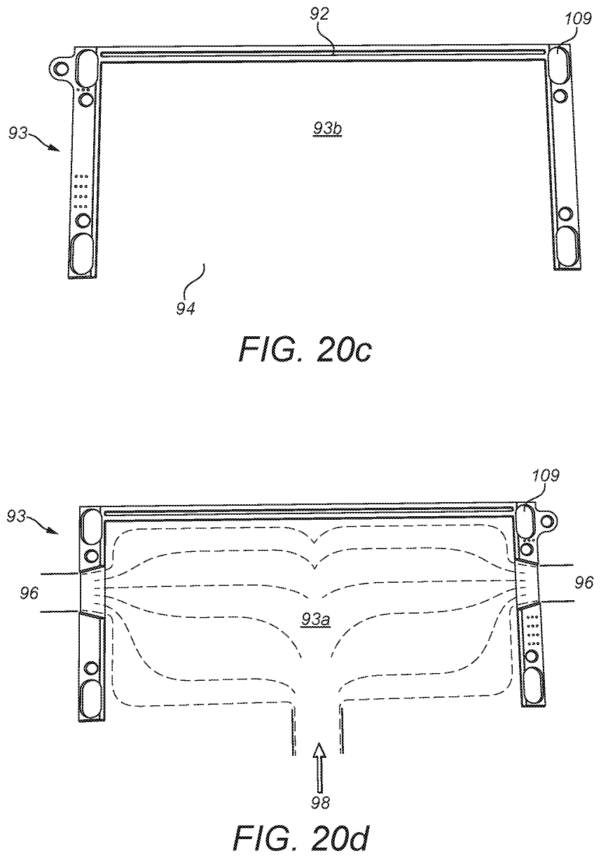

FIG. 18a shows an example of a conventional fuel cell 50-1 with an anode-cathode-anode-cathode (bi-polar) 8-module stack configuration with nine slots for air flow. ‘Slot’ is used herein to describe an inlet or an outlet in a fuel cell or a fuel cell board. Each module comprises 11 fuel cell boards, making an 88-cell-stack fuel cell. The fuel cell 50-1 comprises a fan 52 for directing coolant and reactant air flow into and through the eight fuel cell modules, and the air flow exits the fuel cell 50-1 through slots 56. Hydrogen fuel enters through inlets 54a and exits through outlets 54b.

FIG. 18b shows a fuel cell 50-2 according to an embodiment, with an anode-anode-cathode-cathode 8-module stack configuration with five slots for cooling air flow and four slots for reactant air. Again, each module comprises 11 fuel cell boards, making an 88-cell-stack fuel cell. The fuel cell 50-2 comprises a reactant fan 52a for directing reactant air flow and a coolant fan 52b for directing coolant air flow. In this present embodiment, the reactant fan 52a and the coolant fan 52b are arranged such that the reactant air flow is orthogonal to the coolant air flow.

Thus, the reactant air flow exits the fuel cell 50-2 through slots 56a, while the coolant air flow exits the fuel cell 50-2 through slots 56b. Hydrogen fuel enters through inlets 54a and exits through outlets 54b.

The fuel cells of the present embodiments demonstrate performance improvement when the coolant and reactant fluid flows are decoupled in the fuel cell 50-2 in comparison with a combined coolant and reactant fluid flow in the fuel cell 50-1, as outlined in the EXAMPLES later on.

FIG. 18c shows a diagrammatic representation of how the flows can enter and leave the fuel cell 50-2. 51a represents one flow going into the fuel cell, with 51b representing the same flow leaving the fuel cell. 53a represents another flow going into the fuel cell, with 53b representing the same flow leaving the fuel cell. 51a/51b and 53a/53b can either be coolant flow and reactant flow, or the other way around. Whichever way around it is, coolant flow and reactant flow are shown substantially perpendicular to each other. In this embodiment cooling fluid flow can be provided to either side with the reactant flow provided to the perpendicular side. In this embodiment, the coolant and reactant flows flow straight across the plane of the cells, and they leave the side of the cell opposite to the side they entered the cell. Whilst not apparent from this figure, the flows will enter and leave a fuel cell stack, or an individual fuel cell board, at different levels, so as to provide reactant or coolant flow to different layers of the stack. In present embodiments, a multi-stack fuel cell is used. However, the present technique can be applied to a fuel cell with a single fuel cell board, in which case a coolant fluid flow is directed to the anode side of the fuel cell board while a reactant fluid flow is directed to the cathode side of the fuel cell board.

In the present embodiments, spacers are provided between adjacent fuel cell boards. The spacers may be configured with channels and/or conduits for directing a coolant or reactant fluid flow.

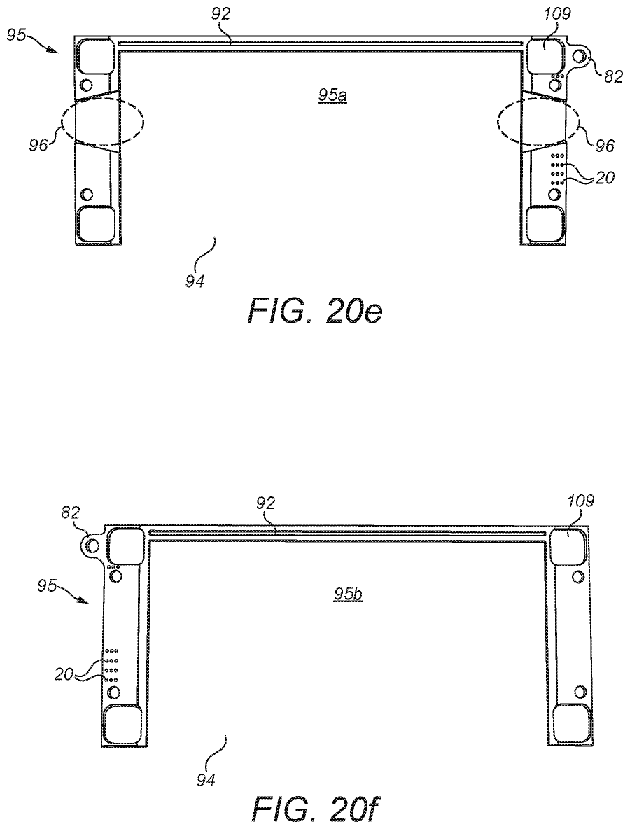

FIG. 19a and FIG. 19b show a fuel cell 80-1 from two different perspectives according to an embodiment, an exemplary 4-module stack. The fuel cell stack is encased in a fuel cell casing with end plate 31 shown. Present in this embodiment are three cathode spacers (one of which is labelled 93 in FIG. 19a), two anode spacers (one of which is labelled 95 in FIG. 19b) and four fuel cell boards 400. Slots 86a, 86b, 88a, 88b in the spacers for air are described shortly. Reactant air and coolant air is supplied via gaps in the stack created by the use of. Multiple electrical connection points 46 are visible.

This has an anode-anode-cathode-cathode 4-module stack configuration with two slots for inlet of cooling air flow and three slots for inlet of reactant air. 5 air inlet/outlet slots 42, 44 are shown for exit of coolant and reactant air, anode slots 42 and cathode slots 44. Each module comprises 11 fuel cell boards, making a 44-cell-stack fuel cell. The fuel cell comprises a reactant fan for directing reactant air flow and a coolant fan for directing coolant air flow (fans not shown). This embodiment has a ‘T-Flow’ air flow design.

Fans can be used in these embodiments as opposed to the air compressors described for the earlier embodiments, because these embodiments do not need as high air pressure, the energy density is lower than that of the earlier embodiments. Fans act as less of an energy parasitic on the system than an air compressor is.

In the present embodiment, the reactant air flow and the coolant air flow are also decoupled, but here arranged such that the reactant air flow is in the opposite entry direction to the coolant air flow. In this embodiment, both the reactant air flow and the coolant air flow enter the stack through inlet slots from opposite sides of the stack. Here, this air enters the two long sides of the stack, but each one from a directly opposite side (here both long sides). The coolant air enters the fuel cell stack through the two slots 88a and the reactant air enters the fuel cell through the three slots 88b. Coolant air flows into the stack so that it only reaches the exposed sides of anodes and the reactant air flows into the stack only so that it reaches the exposed sides of cathodes. In this embodiment, both the reactant air flow and the coolant air flow leave the stack from the short sides of the stacks. In this embodiment, the air flow (for both coolant and reactant air) leaves from a side/in a direction substantially perpendicular to how it entered. Here the reactant air flow exits the fuel cell through slots 86a and the coolant air flow exits the fuel cell through slots 86b (dashed line). Slots 86a and 86b alternate with each other through the stack.

FIG. 19c shows a diagrammatic representation of how the air flow enters and leaves the fuel cell in this embodiment 80-1. 81a represents the coolant air flow into the fuel cell. 83a represents the reactant air flow into the fuel cell. 81b represents the coolant air flow leaving the fuel cell. 83b represents the coolant air flow leaving the fuel cell. Flow is in and out of slots as described above. Coolant and reactant air enter and leave the fuel cell in different planes/plates/boards/levels of the fuel cell, as shown in FIGS. 8a and 8b the slots for entry and exit of the coolant and reactant air are in different plates. Whilst not apparent from this figure, the flows will enter and leave a fuel cell stack, or an individual fuel cell board, at different levels, so as to provide reactant or coolant flow to different layers of the stack. Coolant and reactant flow enters one side, but both leave from two sides.

In the representative embodiment shown herein, the fuel cells typically have long and short sides. However, the fuel cell/fuel cell boards could be different shapes, e.g. square, hexagonal, but in order to achieve the improved air flow dynamics, the reactant and coolant air can enter from opposite sides, but leave from the different sides substantially perpendicular to the side of input, or from two sides when entering one side. Whilst substantially perpendicular airflow is shown in this embodiment other angles (that are not 180, 90 or 0) are also possible, perpendicular is just representative.

The air flow from a single fan on each side of the fuel cell is diverted into the two 88a or three 88b slots on each side. For the reactant air, the central slot of 86a will have air flow going to two sets of interfacing cathodes layers (i.e. two sets of cathode-cathode pairs on different fuel cell boards), the upper and lower or edge slots of 86a only serve one cathode layer. In larger stacks, each central slot or non-edge slot would serve two interfacing cathode layers, with the end slots serving a lone cathode layer. The number of cathode gaps will always be Number of Modules/2+1.

As shown in this embodiment, but applicable for all embodiments herein, a single slot or entry point for cooling or reactant fluid can serve multiple layers flow can enter one slot or entry point and can flow through upwards or downwards to multiple layers, as demonstrated in this embodiment where one reactant air flow slot serves two interfacing cathodes layers.

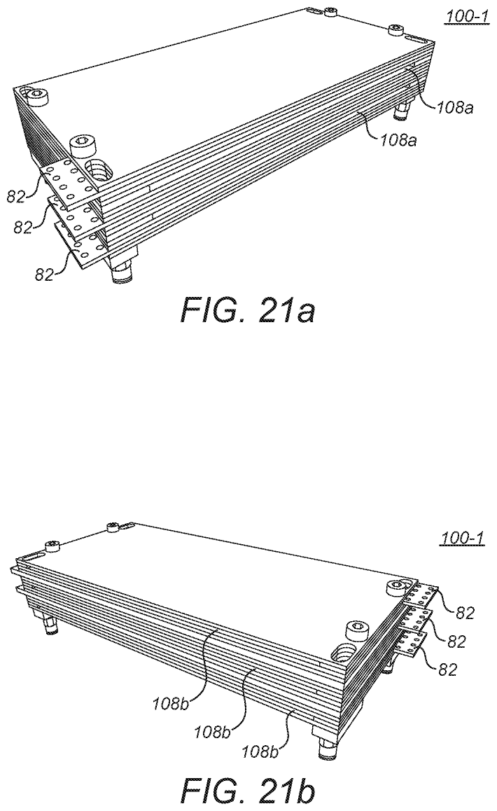

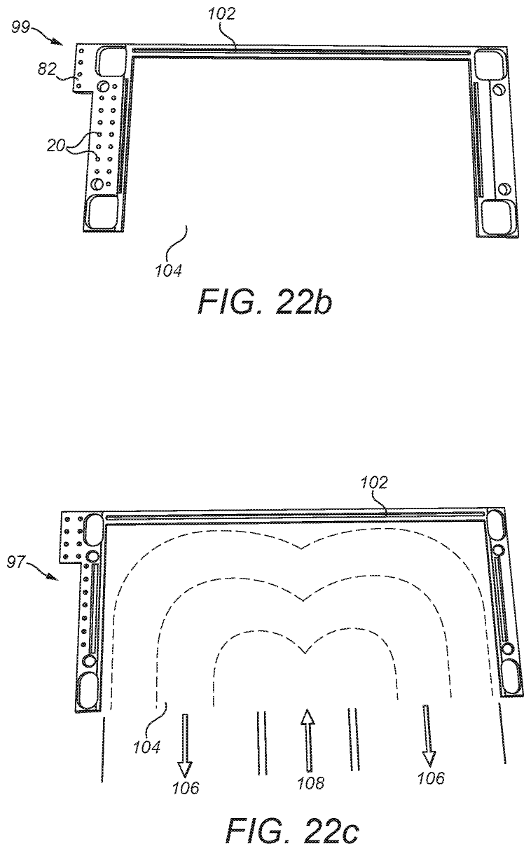

As noted above, spacers separate the fuel cell boards in these embodiments. The inlet and outlet slots for coolant and reactant airflow are in the spacers disposed between adjacent fuel cell boards. In the embodiment of FIGS. 19a and 19b there are five spacers in the stack, spaced between 8 fuel cell boards. Electrical connection points 82 are located on these spacers, three on one side of the fuel cell and two on the other side. These are not labelled in FIGS. 19a and 19b. Exemplary spacers used in the present embodiments can be seen in FIGS. 20a to 20c and FIGS. 22a to 22d.

In the embodiment shown in FIGS. 19a to 19c, the air flow (for both coolant and reactant air) leaves from a side and leaves in a direction substantially perpendicular to how it entered. This embodiment has the additional advantages over the previously described embodiments of the invention as it prevents any large gradients across the length of the stack by reducing the air flow distance in a single direction across the stacks and also acts to reduce air flow pressure. The embodiment shown in FIGS. 19a to 19c have the additional advantage of minimising possible air flow dead spots close to flow entry which can emerge when air flows flow straight across the plane of a cell, and in and out the opposite side to which they entered. This can happen in the exemplary embodiment seen in FIG. 18b and FIG. 18c, where close to air inlet spots may not receive as much flow of coolant or reactant as other parts of the cell.

FIG. 20a shows a top-down perspective of a single cathode spacer 93 used in the fuel cell stack shown in FIGS. 19a, 19b and 19c, showing side 93a of the spacer 93. The dotted circles 96 show the routed areas on the side of the spacer 93 for the exiting air flow. One side 94 is open to allow inlet air, the opposite side 92 of spacer 93 is closed so that air must exit out of the outlet areas 96. Electrical connection point 82 is also labelled. One of the anode manifolds 109 is labelled. Two of the plated through holes 20 are also labelled. FIG. 20b shows a side perspective of the same single spacer 93, with dotted circle 96 showing one of the routed areas on the side of the spacer 93 for the exiting air flow. The other side of spacer 93 is shown in FIG. 20c, showing side 93b. Air exit points 96 are not visible on this side 93b of the spacer 93, as the routing to create the exit hole does not route the whole depth of the spacer 93.

FIG. 20d shows the same spacer 93 as FIGS. 20a, 20b and 20c, side 93a shown face up, with the airflow shown in dotted lines. Airflow enters at inlet side 98 and leaves via outlets 96. Air pressure from the input air ensures a T-shaped flow through the spacer 93, to cool or provide reactant air to the exposed anodes or cathodes that the spacer 93 will be adjacent to. These spacers and this air flow design can be used in for example the fuel cells shown in FIGS. 11a, 11b, 14, 18b, 18c 19a, 19b, and 19c.

FIG. 20e shows a top-down perspective of a single anode spacer 95 used in the fuel cell stack shown in FIGS. 19a, 19b and 19c, showing side 95a of the spacer 95. The dotted circles 96 show the routed areas on the side of the spacer 95 for the exiting air flow. One side 94 is open to allow inlet air, the opposite side 92 of spacer 95 is closed so that air must exit out of the outlet areas 96. Electrical connection point 82 is also labelled. One of the anode manifolds 109 is labelled. Two of the plated through holes 20 are also labelled. The other side of spacer 95 is shown in FIG. 20f, showing side 95b. Air exit points 96 are not visible on this side 95b of the spacer 95, as the routing to create the exit hole does not route the whole depth of the spacer 95.

The size difference between the cathode spacer 93 and the anode spacer 95 width, and indeed other spacers described herein is a result of needing a wider gasket on the anode face which the spacer may hold in place.

In these spacers 93, 95 and other spacers described herein, the copper plating is only on the edges of the spacers, with only one side having conduction between faces. For example, in FIG. 20a this is on the right hand side where plated through holes 20 can be seen and in FIG. 20e this is on the left hand side. As described above the spacers in the open cathode stacks e.g. cathode spacer 93 are conductive on one side only, the conductive part of the spacer is highlighted 23 in FIG. 14. The spacers are copper plated only along their edge. In these embodiments the current will “zigzag” up/down and across a stack of multiple fuel cell boards 400 in order to put all the cells in series. Anode spacers 95 are conductive (i.e. have plated through holes) on the opposite side of the spacer to the side which is conductive of the cathode spacer 93. If copper was plated anywhere else on a spacer, an electrical short between adjacent cells on a module may occur. The copper on the non-conductive side is present such that one side of the spacer isn't thicker than the other. This enables an even compression over the seals which are only present on the sides of the module. The gaskets that sit in the spacers that seal between adjacent modules are all in the corners of the stack. By adding the copper on the short edge of the spacer, the thickness at this point throughout the stack is the same.

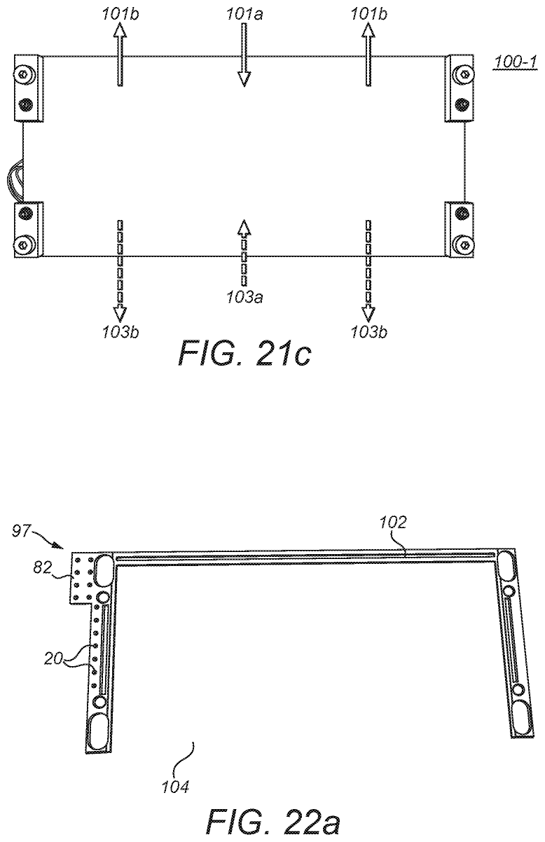

An alternative embodiment to the T-Flow air flow design shown in FIGS. 20a, 20b, 20c, 20c, 20d, 20e, 20f is a ‘U-Flow air flow’ design. The fuel cells demonstrating this are shown in FIGS. 21a, 21b and 21c, spacers shown in FIGS. 22a to 22c. These spacers with an alternative design to those shown in FIGS. 20a, 20b and 20c can provide different air flow to that shown in FIG. 20c. These spacers and this air flow design can be used in for example the fuel cells shown in FIGS. 11a, 11b, 14, 18b, 18c 19a, 19b, and 19c. FIG. 22a shows a cathode spacer and FIG. 22 an anode spacer.

FIG. 21a shows a fuel cell 100-1 from two different perspectives according to an embodiment. This has an anode-anode-cathode-cathode 4-module stack configuration with two slots for inlet of cooling air flow and three slots for inlet of reactant air. In this embodiment, both coolant and reactant air have inlet and outlet on the same side of the fuel cell. Compared to the embodiment shown in FIGS. 19a, 19b and 19c, there are no separate outlet slots (86a, 86b in FIGS. 19a, 19b and 19c). Here, 3 combined inlet/outlet slots are shown for combined input and output of reactant air, and 2 combined inlet/outlet slots are shown for combined input and output of coolant air. Each module comprises 11 fuel cell boards, making a 44-cell-stack fuel cell. The fuel cell comprises a reactant fan for directing reactant air flow and a coolant fan for directing coolant air flow (fans not shown). This embodiment has a U-Flow air flow design.

In the present embodiment, the reactant air flow and the coolant air flow are also decoupled, and here also arranged such that the reactant air flow is in the opposite entry direction to the coolant air flow. In this embodiment, both the reactant air flow and the coolant air flow enter the stack through inlet slots from opposite sides of the stack. This air enters the two long sides of the stack, but each one from a directly opposite side (here both long sides). The coolant air enters the fuel cell stack through the two slots 108a and the reactant air enters the fuel cell through the three slots 108b. Coolant air flows into the stack so that it only reaches the exposed sides of anodes, and the reactant air flows into the stack only so that it reaches the exposed sides of cathodes. This is all the same in principle as the embodiment shown in FIGS. 19a, 19b, 19c.

In this embodiment, both the reactant air flow and the coolant air flow leave the stack from the same side of the stack as they enter. Slot 108a also acts as the outlet for the coolant air and slot 108b acts as the outlet for the reactant air. Electrical connection points 82 are also labelled.

FIG. 21c shows a diagrammatic representation of how the air flow enters and leaves the fuel cell in this embodiment 100-1. 101a represents the coolant air flow into the fuel cell. 103a represents the reactant air flow into the fuel cell. 101b represents the coolant air flow leaving the fuel cell. 103b represents the reactant air flow leaving the fuel cell. Flow is in and out of slots as described above. Coolant and reactant air enter and leave the fuel cell in different planes/plates/boards/levels of the fuel cell, as shown in FIG. 21a and FIG. 21b the slots for entry and exit of the coolant and reactant air are in different spacers in different levels. Here, the coolant and reactant air flows are still decoupled and input is opposite to each other. Whilst not apparent from this figure, the flows will enter and leave a fuel cell stack, or an individual fuel cell board, at different levels, so as to provide reactant or coolant flow to different layers of the stack.

In the embodiment shown in FIGS. 21a to 21c, the air flow (for both coolant and reactant air) leaves from a side/in a direction the same as it entered. This embodiment has the same additional advantages over the embodiments described in FIG. 5b/7c as the embodiment shown in FIGS. 19a to 19c-minimising possible air flow dead spots which can emerge when air flows flow straight across the plane of a cell, and acting to prevent any large gradients across the length of the stack by reducing the air flow distance across the stacks by reducing air flow pressure. This embodiment has the additional advantage of simplifying product design and manufacture as air only needs to be serviced at two sides of the stack, much like a traditional fuel cell stack (e.g. that described in FIG. 5a), but with the advantages of the de-coupled coolant and reactant air flows and also the advantages of the T-Flow design over a traditional fuel cell stack. The spacers are easier to manufacture in the U-Flow design.

FIG. 22a shows a top-down perspective of a single cathode spacer 97 used in the fuel cell stack shown in FIGS. 21a, 21b and 21c. One side 104 is open to allow inlet and outlet of air, the opposite side 102 is closed so that air must exit out of the opposite side 104. Electrical connection point 82 is also labelled. FIG. 22b shows single anode spacer 99 used in the fuel cell stack shown in FIGS. 21a, 21b and 21c. One side 104 is open to allow inlet and outlet of air, the opposite side 102 is closed so that air must exit out of the opposite side 104. In both the cathode spacer 97 and the anode spacers 99 plated through holes 20 are only located on one side of the spacers 97, 99, so the spacers are only conductive on one side of the spacers 97, 99, and conductivity through a stack works as described above. FIG. 22c shows the same spacer 97 as FIG. 22a, the cathode spacer 97, with the airflow shown in dotted lines. Airflow enters at 108 and leaves around 106. Air pressure from the input air ensures a U-shaped flow through the spacer, to cool or provide reactant air to the exposed anodes or cathodes that the spacer will be adjacent to. No air exit slots 96 are present in the U-shaped spacers, unlike the T-shaped spacers. Airflow will work the same way with the anode spacer 99, not shown diagrammatically.

Spacers such as those shown here could have multiple different fluid paths, of different sizes, shapes and/or dimensions. Fluids could be at different flow rates or different fluid temperatures in different spacers, or at different flow rates or temperatures in different flow paths within the same spacer. Different fluids could be utilised in the same spacer if the flow paths are dimensioned accordingly. This can address varying coolant or reactant need throughout a fuel cell.

When multiple spacers are present in a fuel cell stack, each spacer may have different fluid paths, different sized, shaped or dimensioned fluid paths or be designed to carry different fluids, or they may have fluids at different flow rates or different fluid temperatures. Multiple anode or multiple cathode spacers could be different from each other, as well as anode and cathode spacers being different from each other. This can address varying coolant or reactant need throughout a fuel cell.

Herein the construction of the fuel cell boards and the fuel cell stack is described herein in terms of ‘horizontal’ and ‘vertical’ planes, in accordance with the embodiments illustrated in the Figures. However, these terms are used for clarity only, and are not limiting on the scope of the invention. It will be clear to the reader that the fuel cell boards can be arranged in any plane, not just the horizontal plane. Further, the term ‘directly opposite’ is not limited to the electrodes being in register. The anode lies on one face of the polymer electrolyte and lies directly opposite a cathode on the opposite face of the same electrolyte membrane layer.

Reference herein to “fuel cell boards” or a “fuel cell board” refers to a membrane electrode assembly (MEA) 113 sandwiched between and a PCB cathode plate 101 and a PCB anode plate 102. In the present embodiments, the three layers are laminated together. Some fuel cell boards may have a PCB cap layer also as part of the laminated structure. Fuel cell boards may also be referred to as fuel cell modules herein. The use of ‘fuel cell board’ is not intended to limit the size, shape or arrangement of the MEA, or other components of the board. Fuel cell board is not intended to be limiting on the size, shape or dimensions of the board, it is just a term in the art to refer to the MEAs and PCBs described herein.

Reference herein to “plated through holes” (PTHs) define holes that, on stacking of the fuel cell boards, line up to form a conduit through the fuel cell, said conduit running substantially perpendicular to the planar surfaces of the fuel cell boards. Plated though holes are necessary because PCB material (e.g. FR-4) is electrically insulative so PTHs must be introduced so that copper faces either side of a PCB can become electrically conductive. These may be formed by holes bring drilled through the PCB material (which are in themselves a layer of copper, a layer of FR4, and another layer of copper). These holes then undergo an electroplating dip process such that copper lines the edge of each hole, creating continuity between the two layers of copper of the PCB material. Optional additional steps can occur after this, wherein i) resin can be used fill the remainder of the hole, which is achieved by forcing resin over the PCB such that it flows through any holes present; ii) electroplating dip processing again such that the resin filled holes are capped with copper on both sides; and iii) there may be a mild milling process after this to ensure the surface of the PCB is flat.

In some embodiments, to deposit through-membrane electrical connectors, a metal or other electrically conductive material is chemically deposited within the membrane. The material is preferably chemically stable within the membrane under fuel cell operating conditions, and may typically be a precious metal (e.g. Pt, Au, Ru, Ir, Rh, Pd) or an oxide of a precious metal. Various approaches for depositing conductive bands in the membrane are described in WO2012/117035, the content of which is incorporated herein by reference.

Fuel cell boards here are shown to have multiple anode-cathode pairs. The present techniques can be applied to a fuel cell comprising one or more fuel cell boards each having a single anode-cathode pair, or applied to a fuel cell comprising one or more fuel cell boards comprising multiple anode-cathode pairs on each board.

The coolant fluid may be air or water or any other fluid suitable for extracting heat from within a fuel cell. All coolants known to those of skill in the art would be suitable for the purposes of taking heat from the stack. For example, deionised water or a mixture of water and glycol to prevent freezing of the water can be used. Other suitable coolants are envisioned, and would be known to a person of skill in the art. As described above, the coolant fluid may be air draw in from the atmosphere outside the fuel cell by means of a fan or air compression device.

The reactant fluid may be oxygen gas, air or pressurised air or any other suitable fluid which would be oxidisable at the cathodes. As described above, the reactant fluid for the cathodes may be air draw in from the atmosphere outside the fuel cell by means of a fan or air compression device.

In some embodiments, it may be desirable to supply a cathode reactant fluid that has a different composition or density from a coolant fluid. For example, in aerospace applications, a fuel cell in an aircraft at high altitude may be operating in a low-pressure environment at a reduced oxygen level. To maintain the reaction at the cathodes at a desirable rate, it may be advantageous to increase oxygen level in the reactant air supplied to the cathode. By decoupling the reactant flow from the coolant flow, low-pressure atmospheric air can be pressurised prior to being supplied to the cathodes as reactant air, while unpressurised atmospheric air can be supplied as coolant air to the anodes.

The fuel cells, fuel cell boards and components are predominantly constructed of Printed Circuit Boards (PCB). Individual layers in fuel cells can be constructed from PCBs i.e. the anode plates, cathode plates, which can be adhered together into a solid structure using an epoxy-containing glass fibre composite (“prepeg”). The MEAs may be laser bonded onto a PCB and then to create the fuel cell board, a plurality of boards are laminated together. The gaps between the electrodes, and the sealing achieved in these gaps by the epoxy resin, prevent separate flows from mixing, i.e. prevent air cooling, reactant and fuel flows from mixing. A simple PCB can also be used as the end board or plates in the stacks described herein.

PCBs for the embodiments may be produced in the known way. Insulating layers may be made of dielectric substrates such as FR-1, FR-2, FR-3, FR-4, FR-5, FR-6, CEM-1, CEM-2, CEM-3, CEM-4, CEM-5, polytetrafluoroethylene, and G-10, preferably FR-4, which may be laminated together with an epoxy resin prepreg. In order to yield conductive areas, a thin layer of copper may either be applied to the whole insulating substrate and etched away using a mask to retain the desired conductive pattern, or applied by electroplating.

The construction of fuel cells from PCBs and their advantages are further described in WO2013/164639, which is incorporated herein by reference.

In some embodiments, a catalyst layer on the electrodes accelerates a reaction with the fuel (on the anode electrode) and oxidant (on the cathode electrode) to create or consume the ions and electrons. This layer may be made of suitable catalytic material for the reactions of interest, as is commonly understood by a person skilled in the art of fuel cell production. For example, the catalyst layer may be composed of platinum nanoparticles deposited on carbon and bound with a proton conducting polymer (e.g. Nafion™).

Reference herein to ‘flows’ refers to fluids being allowed to flow, or being substantially directed, either with or without assistance, along fluid flow paths, channels or the like.

The fuel cell boards may be constructed in any suitable and desirable dimensions. In some embodiments, the thickness of the electrolyte membrane layer may be between 1-200 μm, and preferably between 5-100 μm. The electrode bands may be 1 mm-5 cm in width, preferably 2 mm-1 cm in width. The gaps between the electrode bands are between 0.1 mm-1.5 cm wide, preferably between 0.2 mm and 1 cm wide. The width of the through-membrane electrical connectors may be 1 μm-2 mm and preferably 10 μm-1 mm.

Reference herein to a passivating ink may refer to a conductive ink, particularly the ink may have a functional conductive element that is carbon based. The ink acts to provide a low through-plane resistance conductive path between the electrode and the current collector while protecting the copper from the corrosive environment of the fuel cell. It does this by passivating any migratory copper which would otherwise cause irreversible damage of the electrolyte/membrane.

Further, the ink may be a carbon ink, it may be a silver paste and polyurethane based ink with conductive elements dispersed in it such as carbon nanotubes or gold/silver nanoparticles these and other inks will be known to a person of skill in the art.

In operation, the fuel cell is enclosed in a housing and is sealed from the atmosphere. Reactants are fed into the fuel cell channels through sealed connections. Seals may, for example, be made of PDMS. In particular, fuel (e.g. H2) and oxidant (e.g. O2) are fed into appropriate channels of the fuel cell stack, with fuel being supplied to the anodes and oxidant to the cathodes. The electrical current thus formed can be taken directly or the output of the fuel cell board can be modulated utilising the aforementioned switch. A constant power output of the stack may be achieved in a variety of ways. For example, all fuel cell boards may be loaded at all times. Alternatively, the fuel cell boards may be divided into groups and these groups may be “switched on” in turn in a synchronous manner (i.e. switching occurs at a defined time for all fuel cell boards). The fuel cell boards may also be switched in an asynchronous or quasi-asynchronous manner—i.e. each fuel cell board is connected and disconnected to the load for a defined period and frequency individually specified for each fuel cell board. By switching the fuel cell boards so that they are only connected to the load for a proportion of the time according to a duty cycle, the output power of the stack can be continuously modified. For example, if over a given sample period of time only 50% of the fuel cell boards are connected to the load, then the output power of the fuel cell stack will be similarly reduced. The manner in which this 50% is achieved may be brought about in a multitude of ways—for example half of the fuel cell boards may be disconnected from the load and half connected for the entire period; alternatively all fuel cell boards may be connected to the load, but each connected for only half of the sample period. Alternatively again, half of the fuel cell boards may be connected to the load for one quarter of the sample period, and the other half for three quarters of the sample period etc. The choice of the specific scheme or duty cycle used may depend on the performance of individual fuel cell boards, the need to avoid localized heating or ‘hot spots’, the need to avoid flooding of cathode sites with product water, the need to prevent dehydration of the membrane, or the need to counteract poisoning of the electrodes. It will be noted that the duty cycle may be predetermined or may be controlled in real time based on monitored performance of the fuel cell, for example in a closed feedback loop with the voltage measuring apparatus described above. Part-time use of fuel cell boards may also improve efficiency as one can achieve optimum load conditions and power conversion for each individual fuel cell board rather than for the fuel cell stack which is a limitation of current designs. By including additional switching and filtering components on the fuel cell boards, a smoothly varying output, for example a sinusoidal wave, may be obtained, in addition to simple “changeovers” or steps from one potential to another.

Each fuel cell board can carry its own electronic circuitry, with each module feeding the power into an electrical bus. That is, each board contains its own power electronics and controller. The latter monitors the performance of the fuel cell electrodes, local humidity and temperature. It can also control the shape memory alloy (SMA) valves to throttle the flow of reactant to the electrodes on that board, as described in more detail below. Thus the power electronics can be put directly onto each horizontal board. In this manner, the status of each electrode can be monitored for degradation. This information gives feedback to enable the electronics to be modulated so a particular board of electrodes can be used less, thereby slowing the degradation process, or by completely shutting down a board of electrodes. This control enables the protection of underperforming boards, thereby increasing the longevity of the entire fuel cell stack.

A further benefit of having electronics directly on each board is that they can each be configured to convey power in a different way. One example is to use the fuel cell to work multiphase electric motors and provide current to different coils at different times, thereby increasing the efficiency, increasing control of performance and increasing control at low torque. Each of the horizontal boards comprising the series of electrodes would drive one phase.

If, for example, an electrode is underperforming or has become faulty, it is not only possible to switch out the affected board using the individual electronics, but it is also possible to stop the fuel or oxidant supply to specific electrodes.

It will be appreciated that aspects of the invention can be interchanged or juxtaposed as appropriate. The fuel used is not restricted to hydrogen, but may be any suitable fuel. For example, the new geometry fuel cell stack described herein is also applicable to methanol used in Direct Methanol fuel cells.

The fuel cell described herein can fuel cells capable of, any envisioned power output for a fuel cell stack. This could be, for example, 200 W of power output, of 150 W power output, of 100 W power output, of 90 W power output, of 80 W power output, of 70 W power output, of 60 W power output, of 50 W power output, of 40 W power output, of 30 W power output, of 20 W power output, of 10 W power output, of 5 W power output. This is the maximum power output of the fuel cells, cells can be set to the power output required as necessary. The fuel cell described herein can fuel cells capable of, for example, at least or a minimum of 5 W power output, at least 10 W power output, at least 20 W power output, at least 30 W power output, at least 40 W power output, at least 50 W power output, at least 60 W power output, at least 70 W power output, at least 80 W power output, at least 90 W power output, at least 100 W power output, at least 150 W power output, at least 200 W power output. Other cathode geometries, such as closed cathode arrangements may be capable of 150 kW and above.

Although the invention as exemplified uses hydrogen as the reactant fuel (i.e. the reducible gas for the anodes), the fuel cells could be used with all suitable pressurised fluids. As used herein “fluid” refers to a substance that has no fixed shape and yields easily to external pressure, for example a gas or a liquid. Fuels for use with the systems and methods as described herein are fluids. These fuels can be hydrogen or a hydrogen-containing mixture, or a hydrocarbon or hydrocarbon derivative. Fuels could be other gaseous fuels, such as methane or propane. Fuels could be other gaseous fuels, such as methane or propane and fluids include oxidants such as air and oxygen.

The systems and methods can be used with pressurised fuel storage units or containers, as are well known in the art. The fuel can be stored in a pressurised storage unit, for example a bottle or canister. These can be, for example at a pressure of between 700 and 10 bar. In particular the fuel storage units can be suitable for use with fuel cells as described herein, i.e. at a pressure of between 150 and 350 bar.

### EXAMPLE DATA

For the experiment, each stack of the fuel cell 50-1 and the fuel cell 50-2 from FIGS. 18a and 18b were supplied with research grade hydrogen at 1.5× stoich (or a minimum flowrate of 0.1 L/min) and 0.5 bar back pressure. The stacks of each fuel cell 50-1 and 50-2 were held at each predetermined current density for ten minutes. Voltage was recorded every second, with the average of the final minute of the current density hold recorded as a data point. Temperature was controlled at 55° C. measured at the external face of a central module for each fuel cell 50-1 and 50-2. Net power was measured by determining the difference between the stack output power and the power consumed by the fan 52 in the case of the fuel cell 50-1, and the difference between the stack output power and the power consumed by the reactant fan 52a and coolant fan 52b in the case of the fuel cell 50-2. Power densities were calculated as a fraction of the total active area. The same modules were used in both configurations 50-1 and 50-2.

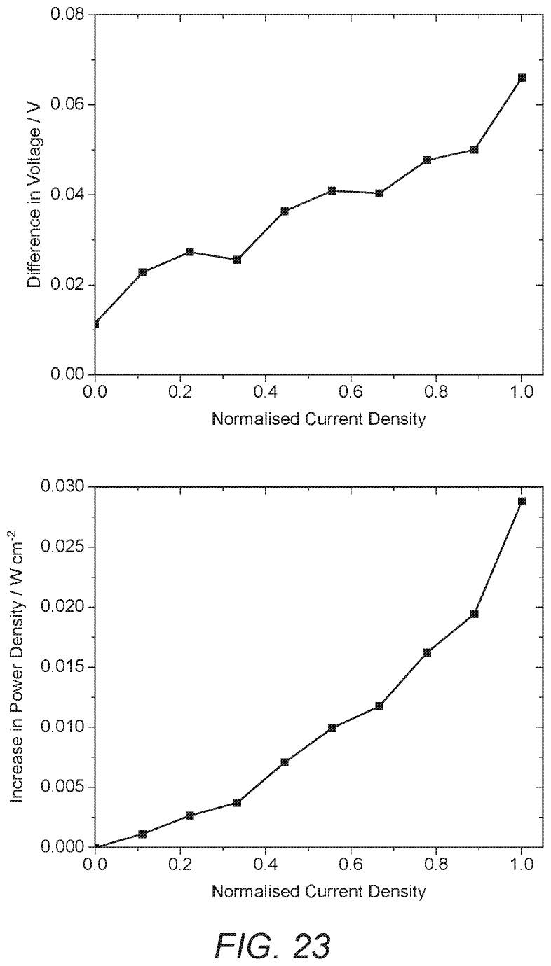

FIG. 23 shows the experimental results of the comparison, which demonstrate performance improvement when the coolant and reactant fluid flows are decoupled in the fuel cell 50-2 in comparison with a combined coolant and reactant fluid flow in the fuel cell 50-1. The top figure evaluates the improvement in voltage at different current density, and the bottom figure evaluates the improvement in power density at different current density.

As can be seen in FIG. 23, increases in performance are more prominent at higher current densities for both voltage output and power density. This is because cooling requirement increases at a much higher rate as current density increases in comparison to reactant requirement. By decoupling the coolant and reactant fluid flows, coolant flow rate to the anodes can be increased as current density increases while humidity can be maintained at the cathodes by selecting a lower reactant flow rate to the cathodes, thereby effectively removing excess heat while hydrating the electrolyte membrane to maintain fuel cell performance.

It will be clear to one skilled in the art that many improvements and modifications can be made to the foregoing exemplary embodiments without departing from the scope of the present disclosure.

The invention claimed is:

1. A fuel cell comprising:
at least one fuel cell board, wherein each fuel cell board comprises:
i) a Membrane Electrode Assembly (MEA) comprising at least one ion permeable membrane, at least one anode, and at least one cathode, wherein each or all anodes are arranged on a first surface of the ion permeable membrane and each or all cathodes are arranged on a second surface of the ion permeable membrane
ii) a first printed circuit board (PCB) layer comprising at least one first fluid path; and
iii) a second PCB layer comprising at least one second fluid path;
wherein the MEA is located between the first PCB layer and the second PCB layer so that the at least one first fluid path is arranged adjacent to each or all of the cathodes such that an oxidant fluid flows to each or all of the cathodes of the at least one fuel cell board and so that the at least one second fluid path is arranged adjacent to each or all of the anodes such that a reductant reducible-fluid flows to the each or all of the anodes of the at least one fuel cell board;
wherein the MEA, the first PCB layer and the second PCB layer are laminated together to form the fuel cell board.

2. The fuel cell of claim 1, wherein the face of the second PCB layer adjacent to the anodes in the fuel cell board comprises the second flow channel, so that the reductant fluid flows to the each or all of the anodes, and
wherein the second PCB layer comprises means to conduct electrical current from one face of the second PCB layer to the other face of the second PCB layer.

3. The fuel cell of claim 1, wherein the fuel cell comprises a plurality of fuel cell boards,
wherein each fuel cell board is arranged such that the first PCB layer and the each or all of the cathodes of each fuel cell board face the second PCB layer and the each or all of the anodes of the adjacent fuel cell board; and
wherein each fuel cell board is arranged such that the second PCB layer and the each or all of the anodes of each fuel cell board the face first PCB layer and the each or all of the cathodes of the adjacent fuel cell board.

4. The fuel cell of claim 3, wherein the fuel cell comprises means to cool at least one fuel cell board, and wherein the means to cool the fuel cell boards is at least one coolant plate, the coolant plate comprising at least one PCB, the PCB comprising a further/third fluid path, wherein the further/third fluid path carries a coolant fluid,
wherein the coolant plate is arranged between the first PCB layer and the second PCB layer of the adjacent fuel cell board, and
wherein the plate comprises means to conduct electrical current from one face of the coolant plate to the other face of the coolant plate,
preferably wherein the coolant plate is laminated to the fuel cell board, optionally wherein the coolant plate is laminated to the second PCB layer of the fuel cell board, or
wherein the coolant plate comprises two PCB layers, and wherein the first layer comprises the further coolant flow field, wherein the first layer is thicker than the second layer, and wherein the second layer seals the flow field of the first layer.

5. (canceled)

6. The fuel cell of claim 1, wherein the face of the first PCB layer adjacent to the cathodes in the fuel cell board comprises the first flow channel, so that oxidant fluid flows to the each or all of the cathodes; and
wherein the first PCB layer comprises means to conduct current from one face of the first PCB layer to the other face of the first PCB layer.

7. The fuel cell of claim 1, wherein the fuel cell comprises a plurality of fuel cell boards and at least two spacers,
wherein each fuel cell board is arranged such that the first PCB layer and the each or all of the cathodes of each fuel cell board face the first PCB layer and the each or all of the cathodes of the adjacent fuel cell board,
wherein each fuel cell board is arranged such that the second PCB layer and the each or all of the anodes of each fuel cell board face the second PCB layer and the each or all of the anodes of the adjacent fuel cell board, and
wherein the spacers separate adjacent stacked fuel cell boards or are at the top and/or the bottom of a stack of one or more fuel cell boards.

8. The fuel cell of claim 7, wherein the fuel cell board comprises plated through holes to form an electrical connection between the at least one anode and at least one cathode, or anodes and cathodes, on the same fuel cell board, or
wherein the spacers have a means to conduct electrical current from one face of the spacer to the other face and wherein the means to conduct electrical current are substantially at only one end of the spacer.

9. (canceled)

10. The fuel cell of claim 7, wherein at least one of the spacers is an anode spacer comprising at least one PCB layer and is a means to cool at least one fuel cell board,
wherein the spacer is located between the second PCB layers of the adjacent fuel cell boards,
wherein spacer comprises at least one third fluid path arranged to carry coolant fluid,
wherein the coolant fluid is air and wherein the fluid flow path is from the atmosphere outside of the fuel cell to the further fluid path arranged to carry coolant fluid.

11. The fuel cell of claim 7, wherein at least one of the spacers is a cathode spacer and comprises at least one PCB layer,
wherein the spacer is located between the first PCB layers of the adjacent fuel cell boards,
wherein the spacer comprises at least one further fluid path arranged to supply an oxidant fluid to the at least one first fluid path,
wherein the oxidant fluid is air and wherein there is a direct fluid flow path from the atmosphere outside of the fuel cell to the further fluid path arranged to supply an oxidant fluid to the at least one first fluid path, or
wherein the fuel cell comprises multiple fuel cell boards, multiple anode spacers and multiple cathode spacers.

12. (canceled)

13. The fuel cell of claim 7, wherein the first PCB layer comprises multiple first fluid paths to supply the oxidant oxidisable fluid to the cathodes at multiple points across each or all cathodes of a single MEA,
wherein the multiple first fluid paths are channels or holes through the body of the first PCB layer, and
wherein the parts of the first PCB layer with channels or holes not formed in the PCB layer are in contact with the cathodes to provide an electrically conductive path from the cathode through the first PCB layer,
wherein the oxidant fluid is air and wherein there is a fluid flow path from the atmosphere outside of the fuel cell to the further fluid paths arranged to supply air to the multiple first fluid paths, or
wherein at least 40% of surface area of the first PCB layer comprises channels or holes or wherein the ratio of surface area of the first PCB comprising channels or holes to surface area of the first PCB not comprising channels or holes is 60:40, and/or wherein there are at least 100 channels or holes in the first PCB layer to provide the fluid paths.

14. (canceled)

15. The fuel cell of claim 7, wherein the fuel cell board comprises a further PCB layer on top of the first PCB layer to seal the MEA.

16. The fuel cell of claim 7, wherein the plurality of first fluid paths are arranged to direct the oxidant fluid in a direction substantially perpendicular to the direction in which the third fluid path or multiple third fluid paths directs the coolant fluid.

17. The fuel cell of claim 7, wherein the plurality of first fluid paths are arranged to direct the oxidant fluid into the fuel cell board in a direction substantially opposite to the direction in which the third fluid path or multiple third fluid paths direct the coolant fluid into the fuel cell board,
wherein the third fluid paths or multiple third fluid are arranged so that after input of the coolant fluid into the fuel cell board the coolant fluid leaves the fuel cell board in at least one direction substantially perpendicular to the direction it was directed into the fuel cell board, and
wherein the first fluid paths are arranged so that after input of the oxidant fluid into the fuel cell board the oxidant fluid leaves the fuel cell board in at least one direction substantially perpendicular to the direction it was directed into the fuel cell board, or
wherein the third fluid path or multiple third fluid paths are also arranged so that after input of the coolant fluid to the fuel cell board the coolant fluid leaves the fuel cell board in two different directions, both directions substantially perpendicular to the direction the coolant fluid was directed into the fuel cell board, and
wherein the first fluid paths are also arranged so that after input of the oxidant fluid to the fuel cell board the oxidant fluid leaves the fuel cell board in two different directions, both directions substantially perpendicular to the direction the oxidant fluid was directed into the fuel cell board.

18. (canceled)

19. The fuel cell of claim 7, wherein the plurality of first fluid paths are arranged to direct the oxidant fluid into the fuel cell board in a direction substantially opposite to the direction in which the third fluid path or multiple third fluid paths direct the coolant fluid into the fuel cell board,
wherein the third fluid path or multiple third fluid paths are arranged so that after input of the coolant fluid into the fuel cell board the coolant fluid leaves the fuel cell board in at least one direction substantially opposite to the direction it was directed into the fuel cell board, and
wherein the first fluid paths are arranged so that after input of the oxidant fluid into the fuel cell board the oxidant fluid leaves the fuel cell board in at least one direction substantially opposite to the direction it was directed into the fuel cell board, or
wherein the third fluid path or multiple third fluid paths are arranged to direct the coolant fluid into the fuel cell board from a first side of the fuel cell board towards a second side of the fuel cell board opposite the first side and return the coolant fluid to the first side to exit the fuel cell board from the first side.

20. (canceled)

21. The fuel cell of claim 1, wherein the or each fuel cell board comprises a plurality of anodes and a plurality of cathodes, wherein the anodes and cathodes are arranged in pairs opposite each other the membrane.

22. The fuel cell of claim 1, wherein each fuel cell board is connected to an electronic circuit to produce an electrical output, and wherein the connection between each fuel cell board and the electronic circuit is individually switchable.

23. The fuel cell of claim 1, wherein the means to conduct electrical current comprises plated through holes.

24. The fuel cell of claim 1, wherein the oxidant fluid is air and the reductant fluid is hydrogen gas.

25. The fuel cell of claim 1, wherein the fuel cell has a power rating of between 8 W and 100 W or,
wherein the lamination is achieved by chemical bonding by heating layers of prepeg between the PCB layers under pressure and an increased temperature, or
wherein the MEA further comprises a catalyst, or
wherein fluid paths are routed into the PCBs prior to copper plating.

26. (canceled)

27. (canceled)

28. (canceled)

29. The fuel cell of claim 1, wherein fluid flow paths are formed within the PCB layer such that the fluid flow path is routed or grooved within the PCB layer without the routing or groove extending all the way through the PCB layer, or
wherein the PCBs are at least partially coated with a passivating layer after copper plating, or
wherein the first and/or the second fluid path is serpentine.

30. (canceled)

31. (canceled)

32. (canceled)
